(19) United States
(12) Patent Application Publication
(10) Pub. No.: US 2014/0024753 A1
(43) Pub. Date: Jan. 23, 2014

(54) LIQUID CRYSTAL ALIGNMENT AGENT, LIQUID CRYSTAL ALIGNMENT FILM AND LIQUID CRYSTAL DISPLAY ELEMENT

(71) Applicant: CHI MEI CORPORATION, Tainan City (TW)

(72) Inventor: Tsung-Pei Tsai, Tainan City (TW)

(21) Appl. No.: 13/931,479

(22) Filed: Jun. 28, 2013

(30) Foreign Application Priority Data
Jul. 18, 2012 (TW) 101125818

(51) Int. Cl. C09D 179/08; C08K 5/06; C08K 5/20; C08K 5/3415

(52) U.S. Cl. CPC C09D 179/08; C08K 5/3415; C08K 5/06; C08K 5/20
USPC 524/104; 524/376; 524/233

(57) ABSTRACT

A liquid crystal alignment agent contains a polymer and a solvent. The polymer is obtained by subjecting a mixture including a tetracarboxylic dianhydride component and a diamine component to a reaction. The diamine component includes a diamine compound of formula (I) defined herein, a benzimidazole-group-containing diamine compound, and a diamine compound other than the diamine compound of formula (I) and the benzimidazole-group-containing diamine compound. The liquid crystal alignment agent has superior processing stability, and a liquid crystal display element made from the aforesaid liquid crystal alignment agent has superior reliability.

### CROSS-REFERENCE TO RELATED APPLICATION

This application claims priority of Taiwanese application no. 101125818, filed on Jul. 18, 2012.

### BACKGROUND OF THE INVENTION

1. Field of the Invention

This invention relates to a liquid crystal alignment agent, more particularly to a liquid crystal alignment agent which includes a polymer obtained by subjecting a tetracarboxylic dianhydride component and a diamine component to a reaction. The diamine component includes a diamine compound of formula (I) defined hereinafter, a benzimidazole-group-containing diamine compound, and a diamine compound other than the diamine compound of formula (I) and the benzimidazole-group-containing diamine compound. The invention also relates to a liquid crystal alignment film formed from the liquid crystal alignment agent, and a liquid crystal display element including the liquid crystal alignment film.

2. Description of the Related Art

With the increase in requirement for the wide view angle characteristic of a liquid crystal display device, the requirement for the electrical and/or display characteristics of a liquid crystal display element having wide view angle has become stricter. Among the predominant types of liquid crystal display elements, the vertical alignment type of liquid crystal display element is most widely used in the art. In order to provide better electrical and/or display characteristics, the liquid crystal alignment film has become one of the important subjects investigated for enhancing the characteristics of the vertical alignment type of liquid crystal display element.

JP 2010-054872 discloses a polyimide polymer used in a liquid crystal alignment film. The polyimide polymer is obtained by subjecting a tetracarboxylic dianhydride component and a diamine component of formula (I)-(viii) to conduct a polymerization reaction and a dehydration/ring-closure reaction,

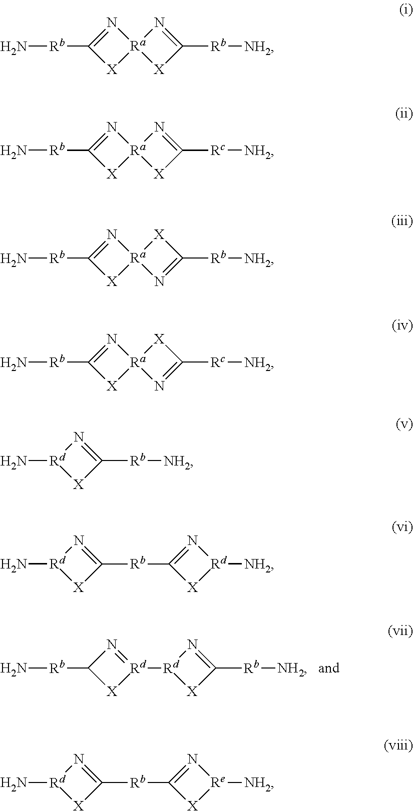

where,

X represents an oxygen atom or NR^{f}, and

R^{f} represents a hydrogen atom, a C₁-C₃₀ alkyl group or a phenyl group;

R^{a}, R^{d}, and R^{e} independently represent an aromatic group or a heterocyclic group; and

R^{b} and R^{c} independently represent an aromatic group, a heterocyclic group, or an alicyclic group.

The object of JP 2010-054872 is to decrease an ion density of a liquid crystal alignment film, thus improving brightness of a liquid crystal display device. However, the polyimide polymer disclosed in JP 2010-054872 is liable to be affected by the processing conditions during the alignment treatment, which results in reduction of alignment capability of the liquid crystal alignment film, thus leading to an inferior uniformity of the pretilt angle of the liquid crystal molecules. Therefore, there is a problem in terms of processing stability. Furthermore, when the liquid crystal display element containing the liquid crystal alignment film is tested in high temperature and high humidity conditions, there is a problem of inferior reliability.

### SUMMARY OF THE INVENTION

Therefore, a first object of the present invention is to provide a liquid crystal alignment agent which has superior processing stability.

A second object of the present invention is to provide a liquid crystal alignment filmmade from the liquid crystal alignment agent.

A third object of the present invention is to provide a liquid crystal display element having superior reliability.

According to a first aspect of this invention, there is provided a liquid crystal alignment agent which includes a polymer and a solvent. The polymer is obtained by subjecting a mixture including a tetracarboxylic dianhydride component and a diamine component to a reaction.

The diamine component includes a diamine compound of formula (I), a benzimidazole-group-containing diamine compound, and a diamine compound other than the diamine compound of formula (I) and the benzimidazole-group-containing diamine compound,

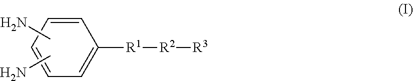

where

R¹ represents a C₁-C₁₂ alkylene group or a C₁-C₁₂ haloalkylene group,

R² represents

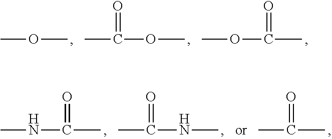

and

R³ represents a cholesteryl group, an organic group of formula (II), or a group of —R³¹—R³²—R³³,

where

R³¹ represents a C₁-C₁₀ alkylene group,

R³² represents

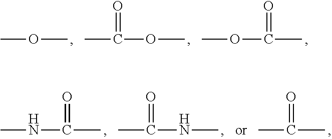

and

R³³ represents a cholesteryl group or an organic group of formula (II),

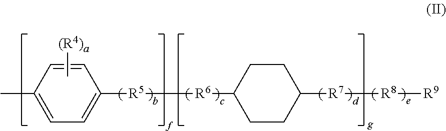

where

each R⁴ independently represents hydrogen, fluorine, or methyl,

each of R⁵, R⁶, and R⁷ independently represents a single bond,

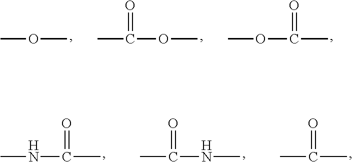

or a C₁-C₃ alkylene,

each R⁸ independently represents

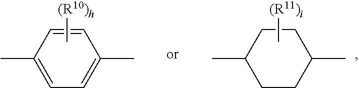

where

each of R¹⁰ and R¹¹ independently represents hydrogen, fluorine, or methyl,

each R⁹ independently represents hydrogen, fluorine, a C₁-C₁₂ alkyl group, a C₁-C₁₂ fluoroalkyl group, a C₁-C₁₂ alkoxyl group, —OCH₂F'′—OCHF₂, or —OCF₃,

a represents 1 or 2,

b, c, and d independently represent an integer ranging from 0 to 4,

e, f, and g independently represent an integer ranging from 0 to 3 with the proviso that e, f, and g are not 0 at the same time, and

h and i independently represent 1 or 2.

According to a second aspect of this invention, there is provided a liquid crystal alignment film formed from the liquid crystal alignment agent.

According to a third aspect of this invention, there is provided a liquid crystal display element including the liquid crystal alignment film disposed on a substrate.

In the present invention, the liquid crystal alignment agent which includes the polymer obtained using the diamine compound of formula (I) and the benzimidazole-group-containing diamine compound has superior processing stability, and the liquid crystal display element including the liquid crystal alignment film formed from the liquid crystal alignment agent has superior reliability.

### BRIEF DESCRIPTION OF THE DRAWING

Other features and advantages of the present invention will become apparent in the following detailed description of the preferred embodiments with reference to the accompanying drawing, of which:

FIG. 1 is a fragmentary schematic view of a preferred embodiment of a liquid crystal display element according to this invention.

### DETAILED DESCRIPTION OF THE PREFERRED EMBODIMENTS

### Liquid Crystal Alignment Agent:

The liquid crystal alignment agent of the present invention includes a polymer and a solvent. The polymer is obtained by subjecting a mixture containing a tetracarboxylic dianhydride component and a diamine component to a reaction. The diamine component includes at least one diamine compound of formula (I), at least one benzimidazole-group-containing diamine compound, and at least one diamine compound other than the diamine compound of formula (I) and the benzimidazole-group-containing diamine compound.

Preferably, the diamine compound of formula (I) is in an amount ranging from 10 moles to 55 moles and the benzimidazole-group-containing diamine compound is in an amount ranging from 5 moles to 40 moles based on 100 moles of the diamine component.

A molar ratio of the diamine compound of formula (I) to the benzimidazole-group-containing diamine compound ranges preferably from 0.5 to 10, more preferably from 0.7 to 7, and most preferably from 1 to 5. When the molar ratio of the diamine compound of formula (I) to the benzimidazole-group-containing diamine compound is in the range defined above, the liquid crystal alignment agent has superior processing stability.

The polymer used in the present invention has an imidization ratio ranging preferably from 30% to 90%, more preferably from 35% to 90%, and most preferably from 40% to 90%. When the imidization ratio of the polymer is in the range defined above, the liquid crystal display element including the liquid crystal alignment film formed from the liquid crystal alignment agent has better reliability.

The components for preparing the liquid crystal alignment agent of the present invention will now be described in detail as follows.

### Diamine Compound of Formula (I):

The diamine compound is of formula (I):

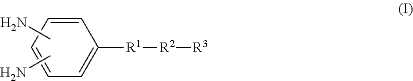

where

R¹ represents a C₁-C₁₂ alkylene group or a C₁-C₁₂ haloalkylene group,

R² represents

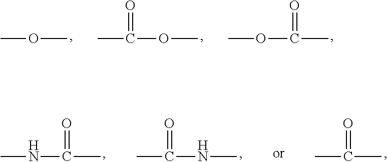

and

R³ represents a cholesteryl group, an organic group of formula (II), or a group of —R³¹—R³²—R³³,

where

R³¹ represents a C₁-C₁₀ alkylene group,

R³² represents

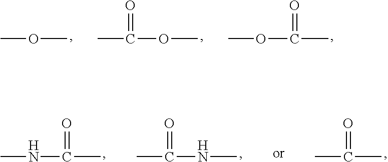

and

R³³ represents a cholesteryl group or an organic group of formula (II),

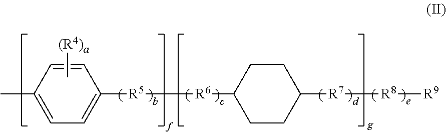

where

each R⁴ independently represents hydrogen, fluorine, or methyl,

each of R⁵, R⁶, and R⁷ independently represents a single bond,

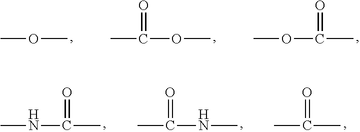

or a C₁-C₃ alkylene,

each R⁸ independently represents

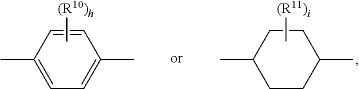

where

each of R¹⁰ and R¹¹ independently represents hydrogen, fluorine or methyl,

each R⁹ independently represents hydrogen, fluorine, a C₁-C₁₂ alkyl group, a C₁-C₁₂ fluoroalkyl group, a C₁-C₁₂ alkoxyl group, —OCH₂F'′—OCHF₂, or —OCF₃,

a represents 1 or 2,

b, c, and d independently represent an integer ranging from 0 to 4,

e, f and g independently represent an integer ranging from 0 to 3 with the proviso that e, f, and g are not 0 at the same time,

h and i independently represent 1 or 2.

Preferably, R¹ represents a C₁-C₈ alkylene group.

The diamine compound of formula (I) is in an amount ranging preferably from 10 moles to 55 moles, more preferably from 15 moles to 50 moles, and most preferably from 20 moles to 45 moles based on 100 moles of the diamine component.

If the diamine compound of formula (I) is not used in the diamine component, then the liquid crystal alignment agent which includes the polymer formed from the diamine component exhibits inferior processing stability, and the liquid crystal display element including the liquid crystal alignment film formed from such liquid crystal alignment agent exhibits inferior reliability.

Examples of the diamine compound of formula (I) include, but are not limited to, 1-cholesteryloxymethyl-2,4-diaminobenzene, 2-cholesteryloxyethyl-2,4-diaminobenzene, 3-cholesteryloxypropyl-2,4-diaminobenzene, 4-cholesteryloxybutyl-2,4-diaminobenzene, 1-cholesteryloxymethyl-3,5-diaminobenzene, 2-cholesteryloxyethyl-3,5-diaminobenzene, 3-cholesteryloxypropyl-3,5-diaminobenzene, 4-cholesteryloxybutyl-3,5-diaminobenzene, 1-(1-cholesteryloxy-1,1-difluoromethyl)-2,4-diaminobenzene, 1-(2-cholesteryloxy-1,1,2,2-tetrafluoroethyl)-2,4-diaminobenzene, 1-(3-cholesteryloxy-1,1,2,2,3,3-hexafluoropropyl)-2,4-diaminobenzene, 1-(4-cholesteryloxy-1,1,2,2,3,3,4,4-octafluorobutyl)-2,4-diaminobenzene, 1-(1-cholesteryloxy-1,1-difluoromethyl)-3,5-diaminobenzene, 1-(2-cholesteryloxy-1,1,2,2-tetrafluoroethyl)-3,5-diaminobenzene, 1-(3-cholesteryloxy-1,1,2,2,3,3-hexafluoropropyl)-3,5-diaminobenzene, 1-(4-cholesteryloxy-1,1,2,2,3,3,4,4-octafluorobutyl)-3,5-diaminobenzene, 1-cholestanyloxymethyl-2,4-diaminobenzene, 2-cholestanyloxyethyl-2,4-diaminobenzene, 3-cholestanyloxypropyl-2,4-diaminobenzene, 4-cholestanyloxybutyl-2,4-diaminobenzene, 1-cholestanyloxymethyl-3,5-diaminobenzene, 2-cholestanyloxyethyl-3,5-diaminobenzene, 3-cholestanyloxypropyl-3,5-diaminobenzene, 4-cholestanyloxybutyl-3,5-diaminobenzene, 1-(1-cholestanyloxy-1,1-difluoromethyl)-2,4-diaminobenzene, 1-(2-cholestanyloxy-1,1,2,2-tetrafluoroethyl)-2,4-diaminobenzene, 1-(3-cholestanyloxy-1,1,2,2,3,3-hexafluoropropyl)-2,4-diaminobenzene, 1-(4-cholestanyloxy-1,1,2,2,3,3,4,4-octafluoropropyl)-2,4-diaminobenzene, 1-(1-cholestanyloxy-1,1-difluoromethyl)-3,5-diaminobenzene, 1-(2-cholestanyloxy-1,1,2,2-tetrafluoroethyl)-3,5-diaminobenzene, 1-(3-cholestanyloxy-1,1,2,2,3,3-hexafluoropropyl)-3,5-diaminobenzene, 1-(4-cholestanyloxy-1,1,2,2,3,3,4,4-octafluoropropyl)-3,5-diaminobenzene, 3-(2,4-diaminophenylmethoxy)-4,4-dimethylcholestane, 3-(2-(2,4-diaminophenyl)ethoxy)-4,4-dimethylcholestane, 3-(3-(2,4-diaminophenyl)propoxy)-4,4-dimethylcholestane, 3-(4-(2,4-diaminophenyl)butoxy)-4,4-dimethylcholestane, 3-(3,5-diaminophenylmethoxy)-4,4-dimethylcholestane, 3-(2-(3,5-diaminophenyl)ethoxy)-4,4-dimethylcholestane, 3-(3-(3,5-diaminophenyl)propoxy)-4,4-dimethylcholestane, 3-(4-(3,5-diaminophenyl)butoxy)-4,4-dimethylcholestane, 3-(1-(2,4-diaminophenyl)-1,1-difluoromethoxy)-4,4-dimethylcholestane, 3-(2-(2,4-diaminophenyl)-1,1,2,2-tetrafluoromethoxy)-4,4-dimethylcholestane, 3-(3-(2,4-diaminophenyl)-1,1,2,2,3,3-hexafluoromethoxy)-4,4-dimethylcholestane, 3-(4-(2,4-diaminophenyl)-1,1,2,2,3,3,4,4-octafluoro methoxy)-4,4-dimethylcholestane, 3-(1-(3,5-diaminophenyl)-1,1-difluoromethoxy)-4,4-dimethylcholestane, 3-(2-(3,5-diaminophenyl)-1,1,2,2-tetrafluoromethoxy)-4,4-dimethylcholestane, 3-(3-(3,5-diaminophenyl)-1,1,2,2,3,3-hexafluoromethoxy)-4,4-dimethylcholestane, 3-(4-(3,5-diaminophenyl)-1,1,2,2,3,3,4,4-octafluoro-methoxy)-4,4-dimethylcholestane, 3-(2,4-diaminophenyl) methoxycholane-24-oic hexadecyl ester, 3-(2-(2,4-diaminophenyl)ethoxy)cholane-24-oic hexadecyl ester, 3-(3-(2,4-diaminophenyl)propoxy)cholane-24-oic hexadecyl ester, 3-(4-(2,4-diaminophenyl)butoxy) cholane-24-oic hexadecyl ester, 3-(3,5-diaminophenyl) methoxycholane-24-oic hexadecyl ester, 3-(2-(3,5-diaminophenyl)ethoxy)cholane-24-oic hexadecyl ester, 3-(3-(3,5-diaminophenyl)propoxy)cholane-24-oic hexadecyl ester, 3-(4-(3,5-diaminophenyl)butoxy) cholane-24-oic hexadecyl ester, 3-(1-(3,5-diaminophenyl)-1,1-difluoromethoxy)cholane-24-oic hexadecyl ester, 3-(2-(3,5-diaminophenyl)-1,1,2,2-tetrafluoromethoxy) cholane-24-oic hexadecyl ester, 3-(3-(3,5-diaminophenyl)-1,1,2,2,3,3-hexafluoropropoxy)cholane-24-oic hexadecyl ester, 3-(4-(3,5-diaminophenyl)-1,1,2,2,3,3,4,4-octafluorobuthoxy)cholane-24-oic hexadecyl ester, 3-(3,5-diaminophenyl)methoxycholane-24-oic stearyl ester, 3-(2-(3,5-diaminophenyl)ethoxy) cholane-24-oic stearyl ester, 3-(3-(3,5-diaminophenyl) propoxy)cholane-24-oic stearyl ester, 3-(4-(3,5-diaminophenyl)butoxy)cholane-24-oic stearyl ester, 3-(1-(3,5-diaminophenyl)-1,1-difluoromethoxy)cholane-24-oic stearyl ester, 3-(2-(3,5-diaminophenyl)-1,1,2,2-tetrafluoromethoxy)cholane-24-oicstearylester, 3-(3-(3,5-diaminophenyl)-1,1,2,2,3,3-hexafluoro propoxy)cholane-24-oic stearyl ester, 3-(4-(3,5-diaminophenyl)-1,1,2,2,3,3,4,4-octafluorobutoxy) cholane-24-oic stearyl ester,

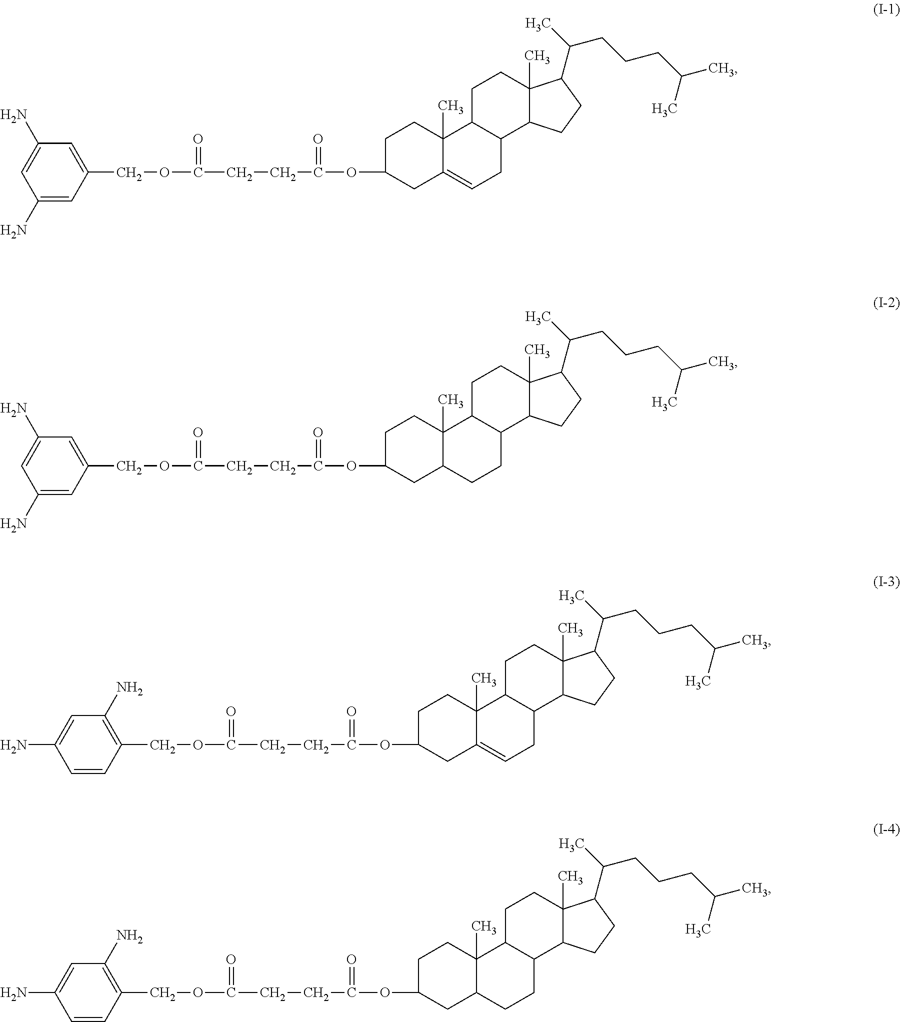 [SMILES: CC(C)CCCC(C)C1CCC2C3CC=C4CC(OC(=O)CCC(=O)OCc5cc(N)cc(N)c5)CCC4(C)C3CCC12C ; CC(C)CCCC(C)C1CCC2C3CCC4CC(OC(=O)CCC(=O)OCc5cc(N)cc(N)c5)CCC4(C)C3CCC12C ; CC(C)CCCC(C)C1CCC2C3CC=C4CC(OC(=O)CCC(=O)OCc5ccc(N)cc5N)CCC4(C)C3CCC12C ; CC(C)CCCC(C)C1CCC2C3CCC4CC(OC(=O)CCC(=O)OCc5ccc(N)cc5N)CCC4(C)C3CCC12C]

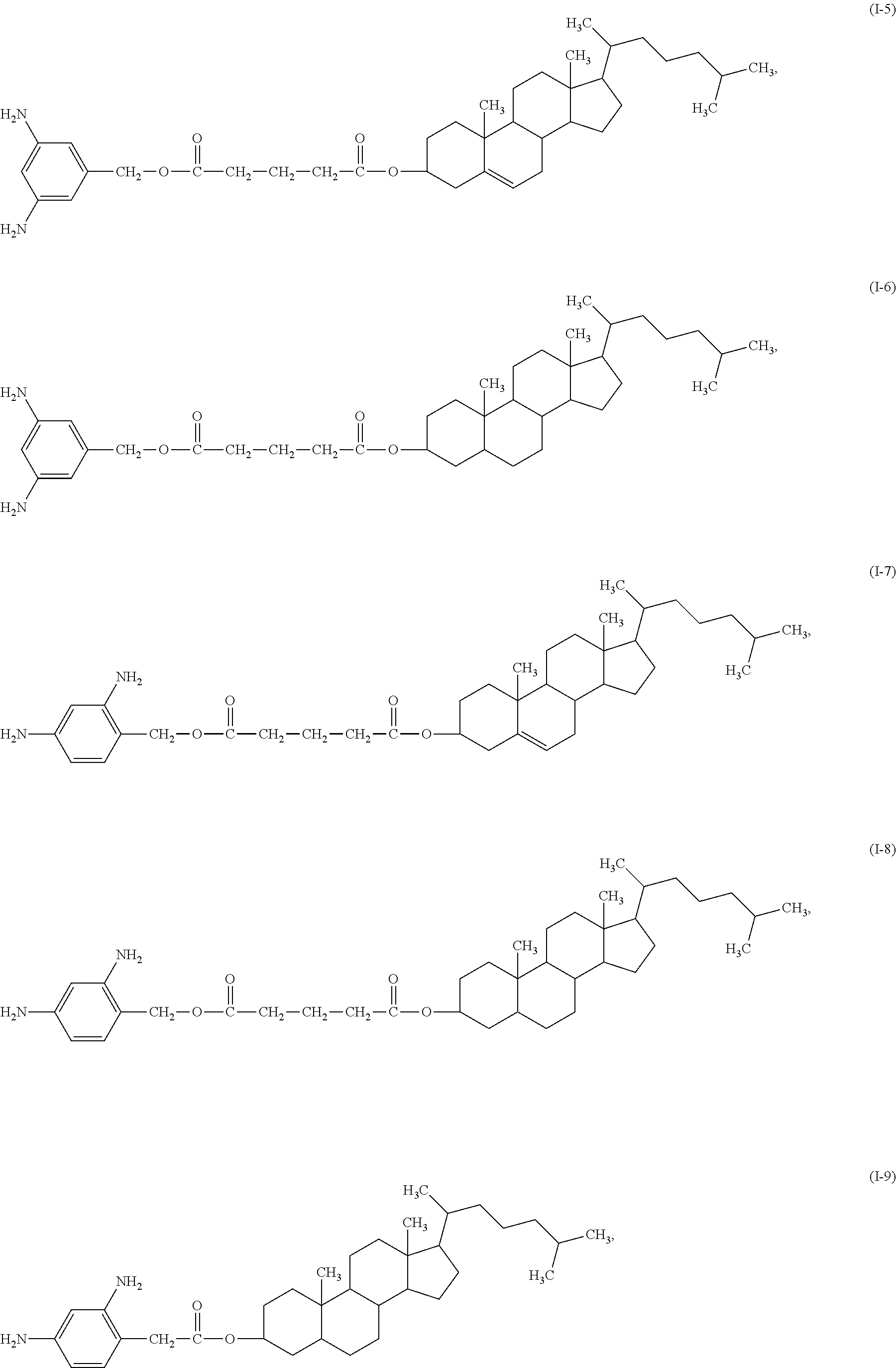 [SMILES: CC(C)CCCC(C)C1CCC2C3CC=C4CC(OC(=O)CCCC(=O)OCc5cc(N)cc(N)c5)CCC4(C)C3CCC12C ; CC(C)CCCC(C)C1CCC2C3CCC4CC(OC(=O)CCCC(=O)OCc5cc(N)cc(N)c5)CCC4(C)C3CCC12C ; CC(C)CCCC(C)C1CCC2C3CC=C4CC(OC(=O)CCCC(=O)OCc5ccc(N)cc5N)CCC4(C)C3CCC12C ; CC(C)CCCC(C)C1CCC2C3CCC4CC(OC(=O)CCCC(=O)OCc5ccc(N)cc5N)CCC4(C)C3CCC12C ; CC(C)CCCC(C)C1CCC2C3CCC4CC(OC(=O)Cc5ccc(N)cc5N)CCC4(C)C3CCC12C]

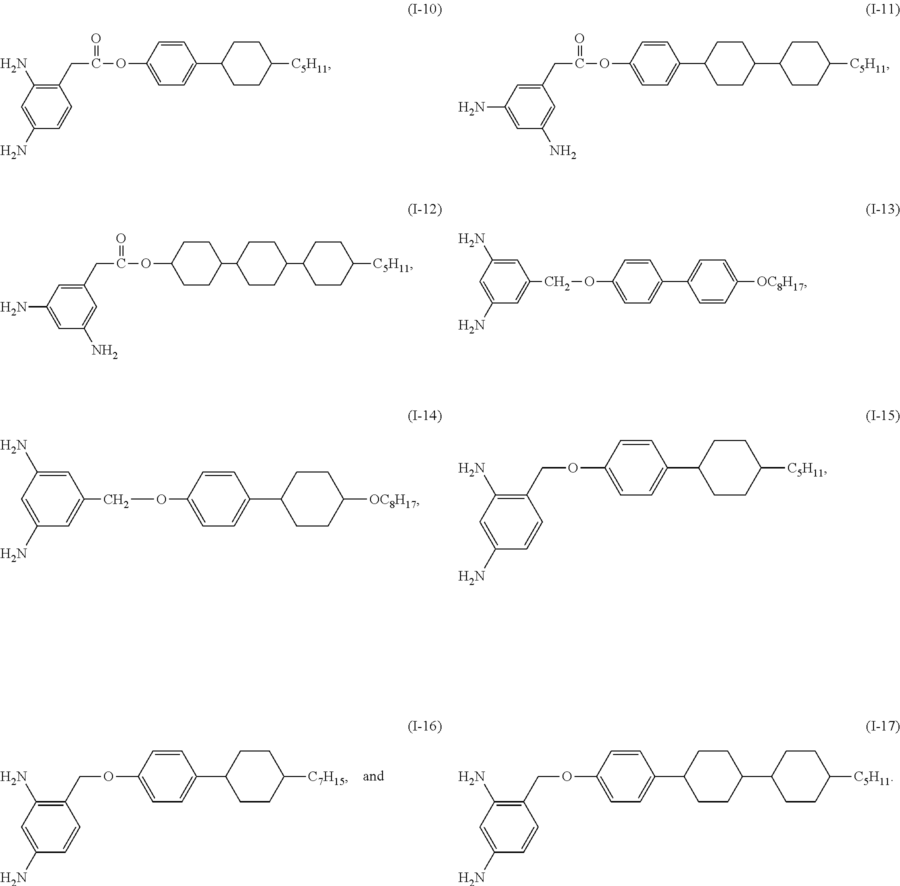

The aforesaid examples of the diamine compound of formula (I) can be used alone or in admixture.

Preferably, the diamine compound represented by Formula (I) is selected from 1-cholesteryloxymethyl-2,4-diaminobenzene, 2-cholesteryloxyethyl-2,4-diaminobenzene, 1-cholesteryloxymethyl-3,5-diaminobenzene, 2-cholesteryloxyethyl-3,5-diaminobenzene, 1-cholestanyloxymethyl-2,4-diaminobenzene, 2-cholestanyloxyethyl-2,4-diaminobenzene, 1-cholestanyloxymethyl-3,5-diaminobenzene, 2-cholestanyloxyethyl-3,5-diaminobenzene, compounds of formulas (I-1), (I-9), (I-10), (I-11), (I-15), and (I-16), and combinations thereof. Commercially available examples of the diamine compound represented by Formula (I) are products such as TWDM-21 and TWDM-23 manufactured by Wako.

### Benzimidazole-Group-Containing Diamine Compound:

The benzimidazole-group-containing diamine compound is selected from the group consisting of diamine compounds of formulas (III)-(VII):

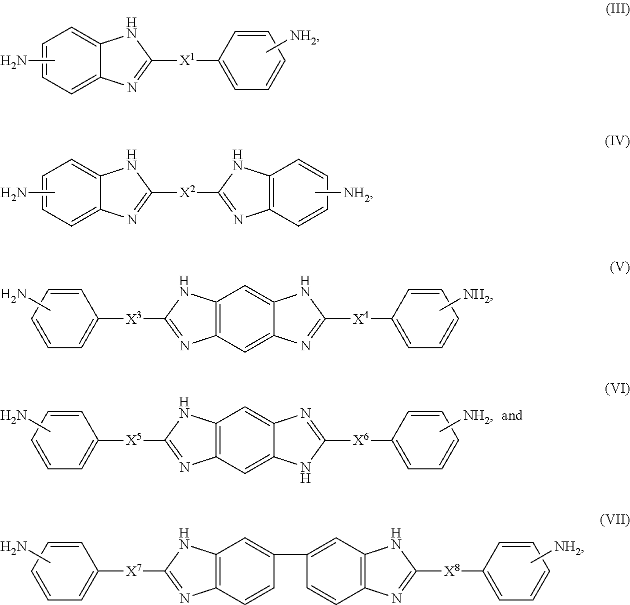

where

X¹, X³, X⁴, X⁵, X⁶, X⁷, and X⁸ independently represent a single bond or a C₁-C₈ alkyl group, and

X² represents a C₁-C₈ alkyl group or phenyl.

The benzimidazole-group-containing diamine compound is in an amount ranging preferably from 5 moles to 40 moles, more preferably from 8 moles to 35 moles, and most preferably from 10 moles to 30 moles based on 100 moles of the diamine component.

When the diamine component for obtaining the polymer for the liquid crystal alignment agent does not contain both the diamine compound represented by Formula (I) and the benzimidazole-group-containing diamine compound, the liquid crystal alignment agent produced therefrom has inferior processing stability and the liquid crystal display element including the liquid crystal alignment agent has inferior reliability.

### Benzimidazole-Group-Containing Diamine Compound of Formula (III):

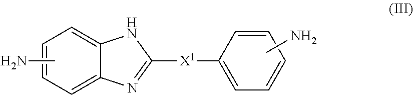

Preferably, in formula (III), X¹ represents a single bond.

Examples of the benzimidazole-group-containing diamine compound of formula (III) include, but are not limited to,

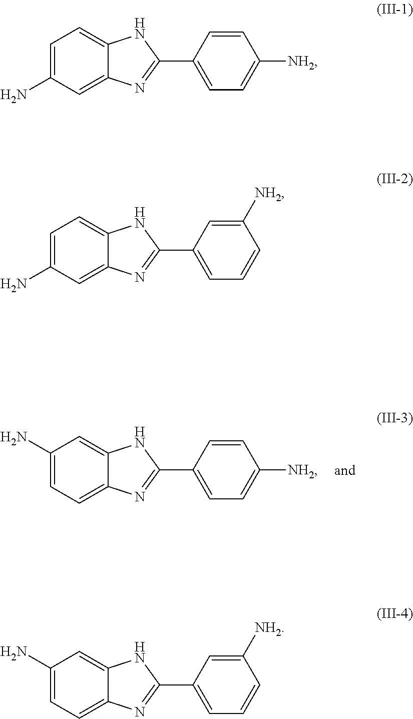 [SMILES: Nc1ccc(-c2nc3cc(N)ccc3[nH]2)cc1 ; Nc1cccc(-c2nc3cc(N)ccc3[nH]2)c1 ; Nc1ccc(-c2nc3ccc(N)cc3[nH]2)cc1 ; "and" ; Nc1cccc(-c2nc3ccc(N)cc3[nH]2)c1]

The aforesaid examples of the benzimidazole-group-containing diamine compound of formula (III) can be used alone or in admixture.

### Benzimidazole-Group-Containing Diamine Compound of Formula (IV):

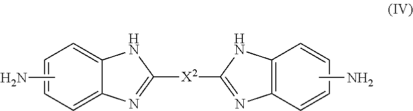

Preferably, in formula (IV), X² represents phenyl.

Examples of the benzimidazole-group-containing diamine compound of formula (IV) include, but are not limited to,

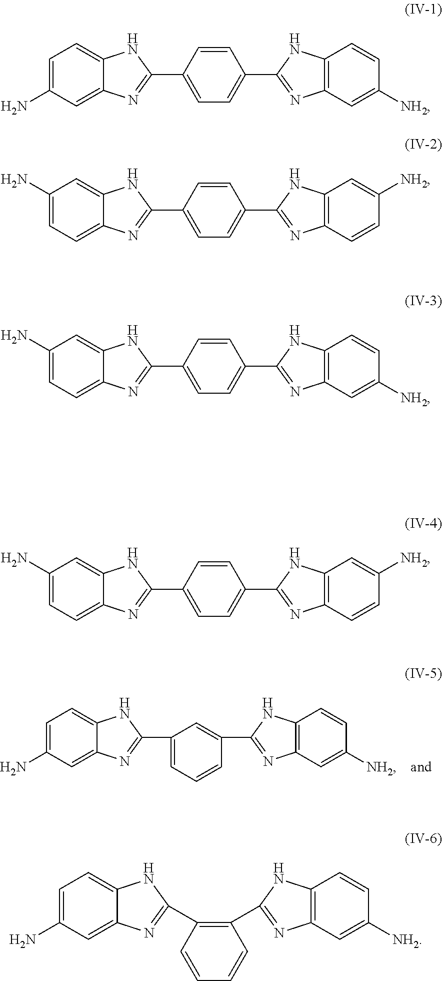

The aforesaid examples of the benzimidazole-group-containing diamine compound of formula (IV) can be used alone or in admixture.

### Benzimidazole-Group-Containing Diamine Compound of Formula (V):

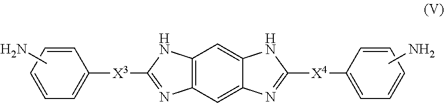

Preferably, in formula (V), X³ and X⁴ independently represent a single bond.

Examples of the benzimidazole-group-containing diamine compound of formula (V) include, but are not limited to,

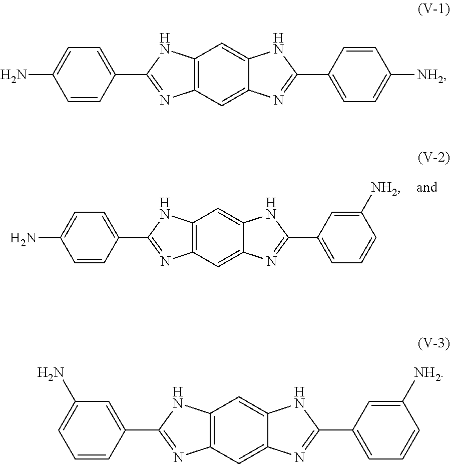 [SMILES: Nc1ccc(-c2nc3cc4nc(-c5ccc(N)cc5)[nH]c4cc3[nH]2)cc1 ; Nc1ccc(-c2nc3cc4nc(-c5cccc(N)c5)[nH]c4cc3[nH]2)cc1 ; "and" ; Nc1cccc(-c2nc3cc4nc(-c5cccc(N)c5)[nH]c4cc3[nH]2)c1]

The aforesaid examples of the benzimidazole-group-containing diamine compound of formula (V) can be used alone or in admixture.

### Benzimidazole-Group-Containing Diamine Compound of Formula (VI):

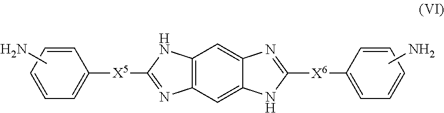

Preferably, in formula (VI), X⁵ and X⁶ independently represent a single bond.

Examples of the benzimidazole-group-containing diamine compound of formula (VI) include, but are not limited to,

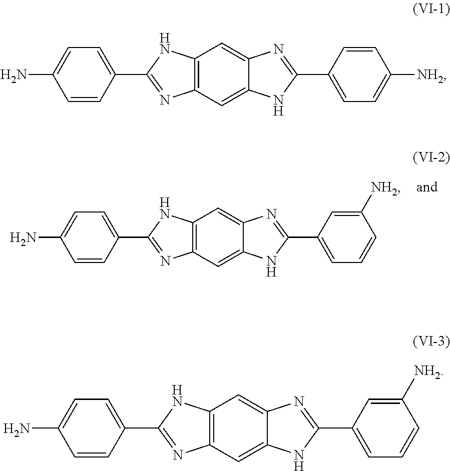 [SMILES: Nc1ccc(-c2nc3cc4[nH]c(-c5ccc(N)cc5)nc4cc3[nH]2)cc1 ; Nc1ccc(-c2nc3cc4[nH]c(-c5cccc(N)c5)nc4cc3[nH]2)cc1 ; "and" ; Nc1ccc(-c2nc3cc4[nH]c(-c5cccc(N)c5)nc4cc3[nH]2)cc1]

The aforesaid examples of the benzimidazole-group-containing diamine compound of formula (VI) can be used alone or in admixture.

### Benzimidazole-Group-Containing Diamine Compound of Formula (VII):

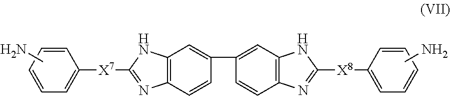

Preferably, in formula (VII), X⁷ and X⁸ independently represent a single bond.

A non-limiting example of the benzimidazole-group-containing diamine compound of formula (VII) is

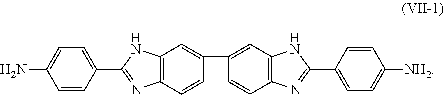 [SMILES: Nc1ccc(-c2nc3ccc(-c4ccc5nc(-c6ccc(N)cc6)[nH]c5c4)cc3[nH]2)cc1]

Preferably, the benzimidazole-group-containing diamine compound is selected from compounds of formulas (III-1), (III-3), (IV-1), (IV-2), (IV-3), (IV-4), (V-1), (VI-1), and combinations thereof.

### Another Diamine Compound:

Examples of another diamine compound other than the diamine compound of formula (I) and the benzimidazole-group-containing diamine compound include, but are not limited to, 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 4,4′-diaminoheptane, 1,3-diamino-2,2-dimethylpropane, 1,6-diamino-2,5-dimethylhexane, 1,7-diamino-2,5-dimethylheptane, 1,7-diamino-4,4-dimethylheptane, 1,7-diamino-3-methylheptane, 1,9-diamino-5-methylnonane, 2,11-diaminododecane, 1,12-diaminooctadecane, 1,2-bis(3-aminopropoxy)ethane, 4,4′-diaminodicyclohexylmethane, 4,4′-diamino-3,3′-dimethyldicyclohexylamine, 1,3-diaminocyclohexane, 1,4-diaminocyclohexane, isophoronediamine, tetrahydrodicyclopentadienylene diamine, tricyclic[6.2.1.02,7]-undecylenedimethylene diamine, 4,4′-methylenebis(cyclohexylamine), 4,4′-diaminodiphenylmethane, 4,4′-diaminodiphenylethane, 4,4′-diaminodiphenylsulfone, 4,4′-diaminobenzanilide, 4,4′-diaminodiphenylether, 3,4′-diaminodiphenylether, 1,5-diaminonaphthalene, 5-amino-1-(4′-aminophenyl)-1,3,3-trimethylindane, 6-amino-1-(4′-aminophenyl)-1,3,3-trimethylindane, hexahydro-4,7-methanoindanylenedimethylene diamine, 3,3′-diaminobenzophenone, 3,4′-diaminobenzophenone, 4,4′-diaminobenzophenone, 2,2-bis[4-(4-aminophenoxy)phenyl]propane, 2,2-bis[4-(4-aminophenoxy)phenyl]hexafluoropropane, 2,2-bis(4-aminophenyl)hexafluoropropane, 2,2-bis[4-(4-aminophenoxy)phenyl]sulfone, 1,4-bis(4-aminophenoxy)benzene, 1,3-bis(4-aminophenoxy)benzene, 1,3-bis(3-aminophenoxy)benzene, 9,9-bis(4-aminophenyl)-10-hydroanthracene, 9,10-bis(4-aminophenyl)anthracene, 2,7-diaminofluorene, 9,9-bis(4-aminophenyl)fluorene, 4,4′-methylene-bis(2-chloroaniline), 4,4′-(p-phenyleneisopropylidene)bisaniline, 4,4′-(m-phenyleneisopropylidene)bisaniline, 2,2′-bis[4-(4-amino-2-trifluoromethylphenoxy)phenyl]hexafluoropropane, 4,4′-bis[(4-amino-2-trifluoromethyl)phenoxy]octafluorobiphenyl, 5-[4-(4-n-pentylcyclohexyl)cyclohexyl]phenylmethylene-1,3-diaminobenzene,
1,1-bis[4-4-aminophenoxy)phenyl]-4-(4-ethylphenyl)cyclohexane, and diamine compounds of formulas (VIII)-(XXI),

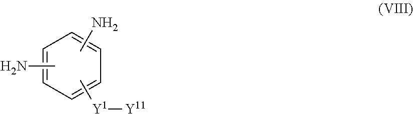

where

Y¹ represents

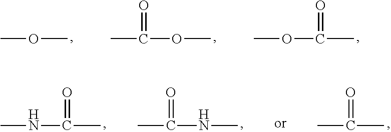

and

Y¹¹ represents a monovalent group having a group selected from the group consisting of a steroid-containing group, a trifluoromethyl group, a fluoro group, a C₂-C₃₀ alkyl group, and a monovalent nitrogen-containing cyclic structure derived from the group consisting of pyridine, pyrimidine, triazine, piperidine and piperazine,

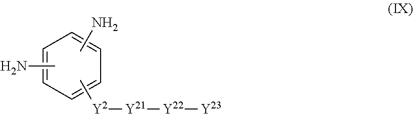

where

Y² represents

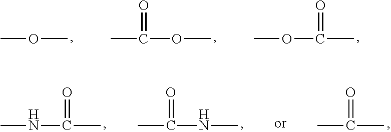

Y²¹ and Y²² independently represent a divalent group which is selected from the group consisting of an alicyclic group, an aromatic group, and a heterocyclic group; and

Y²³ represents a C₃-C₁₈ alkyl group, a C₃-C₁₈ alkoxy group, a C₁-C₅ fluoroalkyl group, a C₁-C₅ fluoroalkoxy group, a cyano group, or a halogen atom,

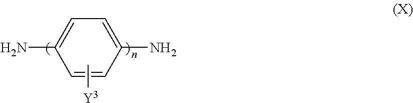

where

Y³ represents hydrogen, a C₁-C₅ acyl group, a C₁-C₅ alkyl group, a C₁-C₅ alkoxy group, or halogen,

Y³ in each repeating unit may be the same or different, and

n is an integer ranging from 1 to 3,

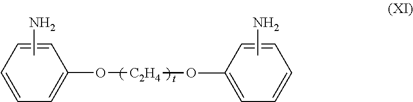

where

t is an integer ranging from 2 to 12,

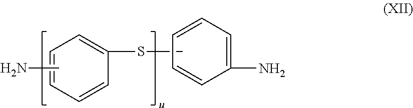

where

u is an integer ranging from 1 to 5,

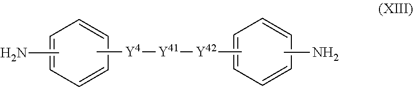

where

Y⁴ and Y⁴² may be the same or different, and independently represent a divalent organic group; and

Y⁴¹ represents a divalent group that has a ring structure containing a nitrogen atom and that is derived from the group consisting of pyridine, pyrimidine, triazine, piperidine and piperazine,

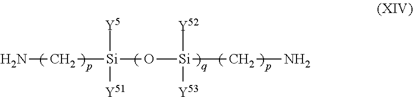

where

Y⁵, Y⁵¹, Y⁵², and Y⁵³ may be the same or different, and independently represent a C₁-C₁₂ hydrocarbon group,

p is an integer ranging from 1 to 3, and

q is an integer ranging from 1 to 20,

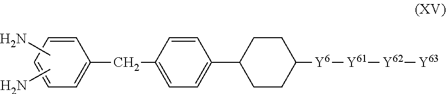

where

Y⁶ represents —O— or cyclohexylene,

Y⁶¹ represents —CH₂—,

Y⁶² represents phenylene or cyclohexylene, and

Y⁶³ represents hydrogen or heptyl,

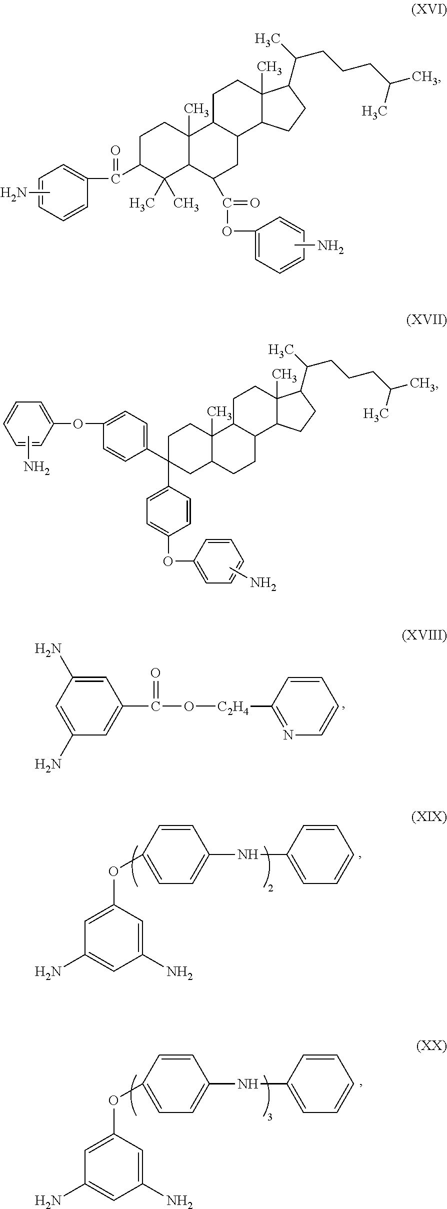

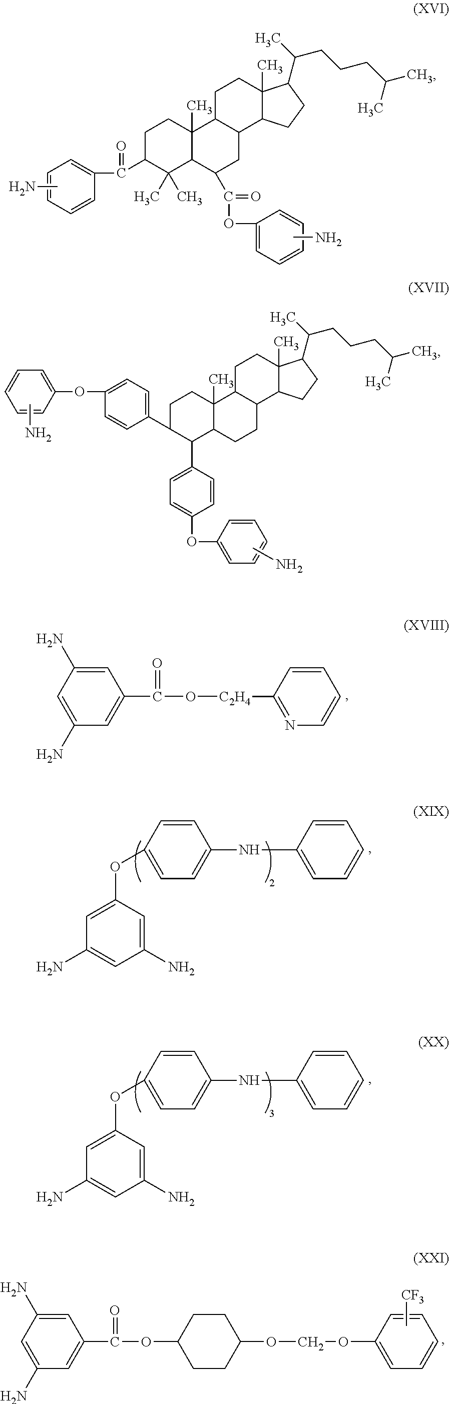

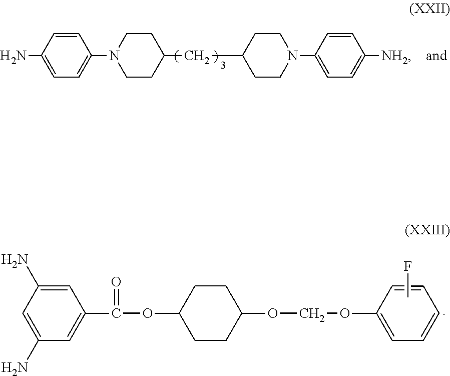

The aforesaid examples of the another diamine compound can be used alone or in admixture.

Preferred examples of the diamine compounds represented by formula (VIII) include 2,4-diaminophenyl ethyl formate, 3,5-diaminophenyl ethyl formate, 2,4-diaminophenyl propyl formate, 3,5-diaminophenyl propyl formate, 1-dodecoxy-2,4-aminobenzene, 1-hexadecoxy-2,4-aminobenzene, 1-octadecoxy-2,4-aminobenzene,

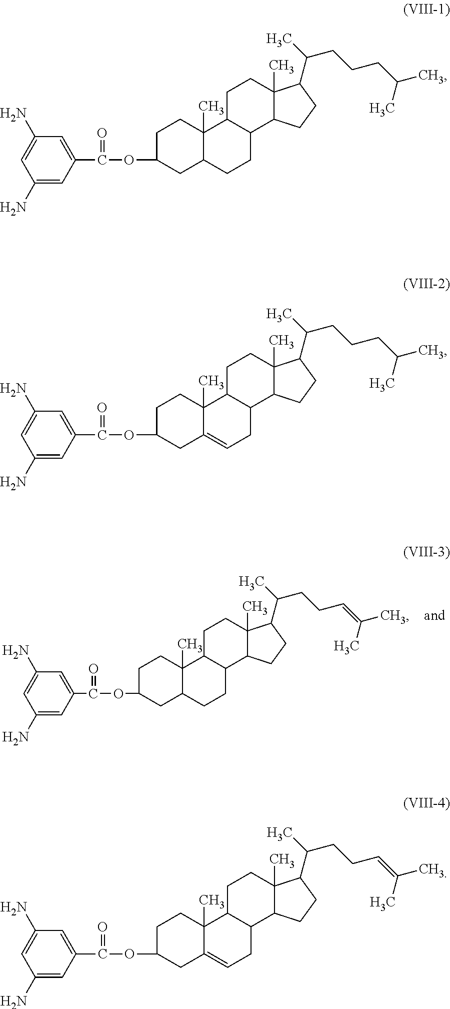 [SMILES: CC(C)CCCC(C)C1CCC2C3CCC4CC(OC(=O)c5cc(N)cc(N)c5)CCC4(C)C3CCC12C ; CC(C)CCCC(C)C1CCC2C3CC=C4CC(OC(=O)c5cc(N)cc(N)c5)CCC4(C)C3CCC12C ; CC(C)=CCCC(C)C1CCC2C3CCC4CC(OC(=O)c5cc(N)cc(N)c5)CCC4(C)C3CCC12C ; "and" ; CC(C)=CCCC(C)C1CCC2C3CC=C4CC(OC(=O)c5cc(N)cc(N)c5)CCC4(C)C3CCC12C]

Preferred examples of the diamine compounds represented by formula (IX) include

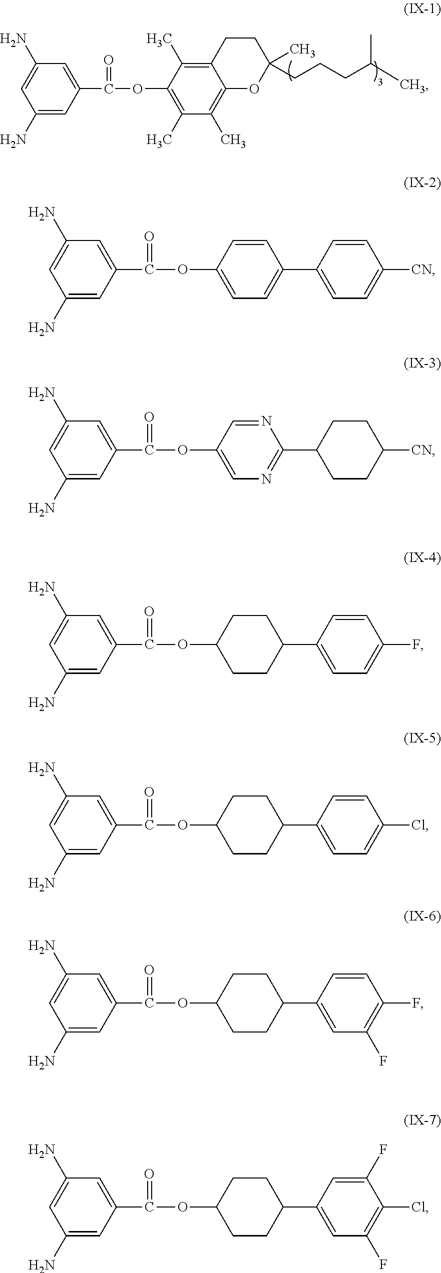

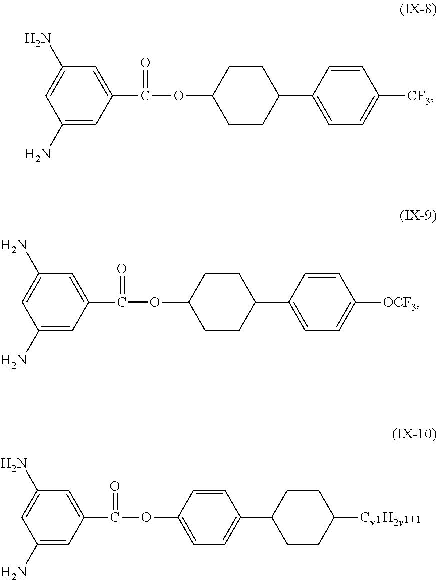

(wherein v¹ represents an integer ranging from 3 to 12),

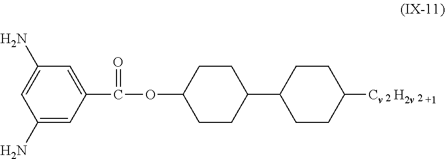

(wherein v² represents an integer ranging from 3 to 12),

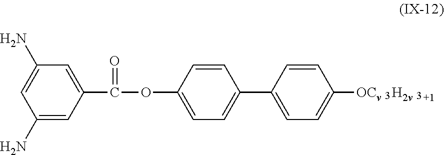

(wherein v³ represents an integer ranging from 3 to 12), and

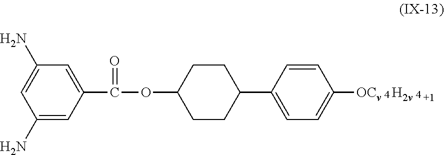

(wherein v⁴ represents an integer ranging from 3 to 12).

Preferred examples of the diamine compound represented by formula (X) include: (1)ₚ-diaminobenzene, m-diaminobenzene, o-diaminobenzene, 2,5-diaminotoluene, or the like when n is 1; (2) 4,4′-diaminobiphenyl, 2,2′-dimethyl-4,4′-diaminobiphenyl, 3,3′-dimethyl-4,4′-diaminobiphenyl, 3,3′-dimethoxy-4,4′-diaminobiphenyl, 2,2′-dichloro-4,4′-diaminobiphenyl, 3,3′-dichloro-4,4′-diaminobiphenyl, 2,2′,5,5′-tetrachloro-4,4′-diaminobiphenyl, 2,2′-dichloro-4,4′-diamino-5,5′-dimethoxybiphenyl, 4,4′-diamino-2,2′-bis(trifluoromethyl)biphenyl, or the like when n is 2; and (3) 1,4-bis(4′-aminophenyl)benzene, or the like when n is 3. More preferably, the diamine compound represented by formula (X) is selected from p-diaminobenzene, 2,5-diaminotoluene, 4,4′-diaminobiphenyl, 3,3′-dimethoxy-4,4′-diaminobiphenyl, and 1,4-bis(4′-aminophenyl)benzene.

Preferably, the diamine compound represented by formula (XII) is 4,4′-diaminodiphenylsulfide.

Preferably, the diamine compound represented by formula (XV) is selected from

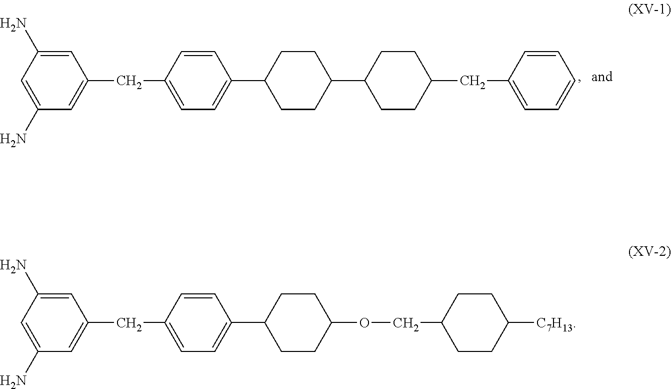

Preferred examples of the another diamine compound suitable for the present invention include, but are not limited to, 1,2-diaminoethane, 4,4′-diaminodicyclohexyl methane, 4,4′-diaminodiphenylmethane, 4,4′-diaminodiphenylether, 5-[4-(4-n-pentylcyclohexyl)cyclohexyl]phenylmethylene-1,3-diaminobenzene, 1,1-bis[4-4-amino-phenoxy)phenyl]-4-(4-ethylphenyl)cyclohexane, 2,4-diaminophenyl ethyl formate, the diamine compounds of formulas (VIII-1), (VIII-2), (IX-1), and (IX-11), p-diaminobenzene, m-diaminobenzene, o-diaminobenzene, the diamine compound represented by formula (XV-1), and combinations thereof.

The another diamine compound is in an amount ranging preferably from 5 moles to 85 moles, more preferably from 15 moles to 77 moles, and most preferably from 25 moles to 70 moles based on 100 moles of the diamine component.

### Tetracarboxylic Dianhydride Component:

The tetracarboxylic dianhydride component includes at least one tetracarboxylic dianhydride compound selected from: (1) an aliphatic tetracarboxylic dianhydride compound, (2) an alicyclic tetracarboxylic dianhydride compound, (3) an aromatic tetracarboxylic dianhydride compound, (4) a teracarboxylic dianhydride compound of the following formulas (1)-(6), and combinations thereof. The aforesaid tetracarboxylic dianhydride compounds can be used alone or as a mixture of two or more.

(1): Examples of the aliphatic tetracarboxylic dianhydride compound include, but are not limited to, ethanetetracarboxylic dianhydride and butanetetracarboxylic dianhydride.

(2): Examples of the alicyclic tetracarboxylic dianhydride compound include, but are not limited to, 1,2,3,4-cyclobutanetetracarboxylic dianhydride, 1,2-dimethyl-1,2,3,4-cyclobutanetetracarboxylic dianhydride, 1,3-dimethyl-1,2,3,4-cyclobutanetetracarboxylic dianhydride, 1,3-dichloro-1,2,3,4-cyclobutanetetracarboxylic dianhydride, 1,2,3,4-tetramethyl-1,2,3,4-cyclobutane tetracarboxylic dianhydride, 1,2,3,4-cyclopentane tetracarboxylic dianhydride, 1,2,4,5-cyclohexane tetracarboxylic dianhydride, 3,3′,4,4′-dicyclohexane tetracarboxylic dianhydride, cis-3,7-dibutylcycloheptyl-1,5-diene-1,2,5,6-tetracarboxylic dianhydride, 2,3,5-tricarboxylcyclopentylacetic dianhydride, and bicyclo[2.2.2]-octa-7-ene-2,3,5,6-tetracarboxylic dianhydride.

(3): Examples of the aromatic tetracarboxylic dianhydride compound include, but are not limited to, 3,4-dicarboxy-1,2,3,4-tetrahydronaphthalene-1-succinic acid dianhydride, pyromellitic dianhydride, 3,3′,4,4′-benzophenonetetracarboxylic dianhydride, 3,3′,4,4′-biphenylsulfonetetracarboxylic dianhydride, 1,4,5,8-naphthalenetetracarboxylic dianhydride, 2,3,6,7-naphthalenetetracarboxylic dianhydride, 3,3′-4,4′-biphenylethanetetracarboxylic dianhydride, 3,3′,4,4′-dimethyldiphenylsilanetetracarboxylic dianhydride, 3,3′,4,4′-tetraphenylsilanetetracarboxylicdianhydride, 1,2,3,4-furantetracarboxylicdianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenylpropane dianhydride, 3,3′,4,4′-perfluoroisopropylidenediphthalic dianhydride, 3,3′,4,4′-diphenyltetracarboxylic dianhydride, bis(phthalic acid)phenylphosphine oxide dianhydride, p-phenylene-bis(triphenylphthalic acid)dianhydride, m-phenylene-bis(triphenylphthalic acid)dianhydride, bis(triphenylphthalic acid)-4,4′-diphenyl ether dianhydride, bis(triphenylphthalic acid)-4,4′-diphenylmethane dianhydride, ethylene glycol-bis (anhydrotrimellitate), propylene glycol-bis(anhydrotrimellitate), 1,4-butanediol-bis(anhydrotrimellitate), 1,6-hexanediol-bis(anhydrotrimellitate), 1,8-octanediol-bis(anhydrotrimellitate), 2,2-bis(4-hydroxyphenyl)propane-bis(anhydrotrimellitate), 2,3,4,5-tetrahydrofurantetracarboxylic dianhydride, 1,3,3a,4,5,9b-hexahydro-5-(tetrahydro-2,5-dioxo-3-furanyl)-naphtho[1,2-c]-furan-1,3-dione, 1,3,3a,4,5,9b-hexahydro-5-methyl-5-(tetrahydro-2,5-dioxo-3-furanyl)-naphtho[1,2-c]-furan-1,3-dione, 1,3,3a,4,5,9b-hexahydro-5-ethyl-5-(tetrahydro-2,5-dioxo-3-furanyl)-naphtho[1,2-c]-furan-1,3-dione, 1,3,3a,4,5,9b-hexahydro-7-methyl-5-(tetrahydro-2,5-dioxo-3-furanyl)-naphtho[1,2-c]-furan-1,3,-dione, 1,3,3a,4,5,9b-hexahydro-7-ethyl-5-(tetrahydro-2,5-dioxo-3-furanyl)-naphtho[1,2-c]-furan-1,3,-dione, 1,3,3a,4,5,9b-hexahydro-8-methyl-5-(tetrahydro-2,5-dioxo-3-furanyl)-naphtho[1,2-c]-furan-1,3-dione, 1,3,3a,4,5,9b-hexahydro-8-ethyl-5-(tetrahydro-2,5-dioxo-3-furanyl)-naphtho[1,2-c]-furan-1,3-dione, 1,3,3a,4,5,9b-hexahydro-5,8-dimethyl-5-(tetrahydro-2,5-dioxo-3-furanyl)-naphtho[1,2-c]-furan-1,3-dione, and 5-(2,5-dioxotetrahydrofuranyl)-3-methyl-3-cyclohexene-1,2-di carboxylic dianhydride.

(4): the teracarboxylic dianhydride compounds represented by the following formulas (1)-(6):

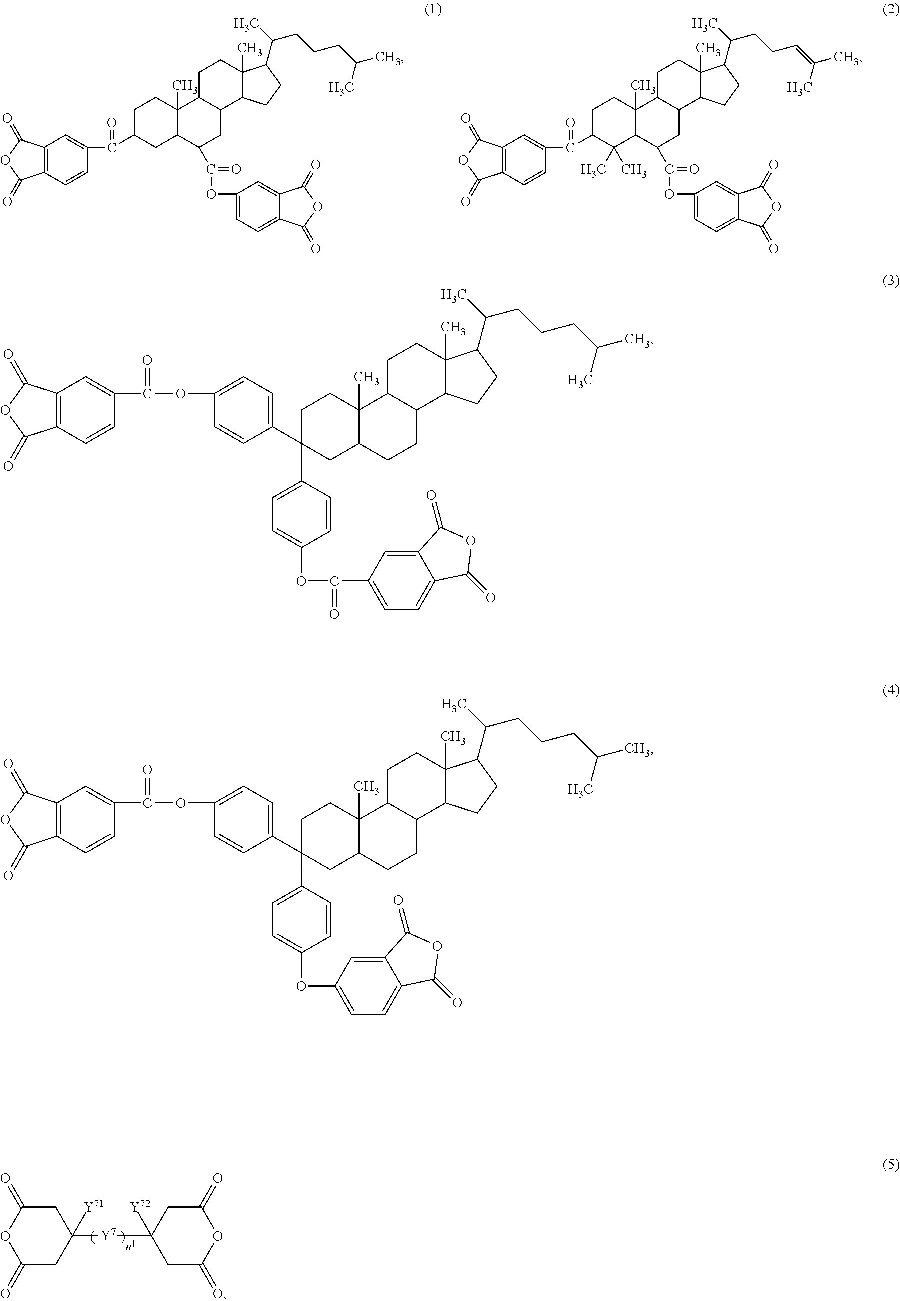

where

Y⁷ represents a divalent group having an aromatic ring structure,

n¹ represents an integer ranging from 1 to 2, and

Y⁷¹ and Y⁷² may be the same or different, and independently represent hydrogen or an alkyl group, and

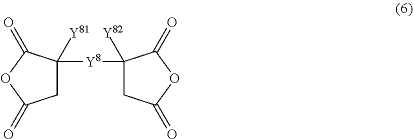

where

Y⁸ represents a divalent group having an aromatic ring structure,

Y⁸¹ and Y⁸² may be the same or different, and independently represent hydrogen or an alkyl group.

Preferably, the tetracarboxylic dianhydride compound represented by formula (5) is selected from

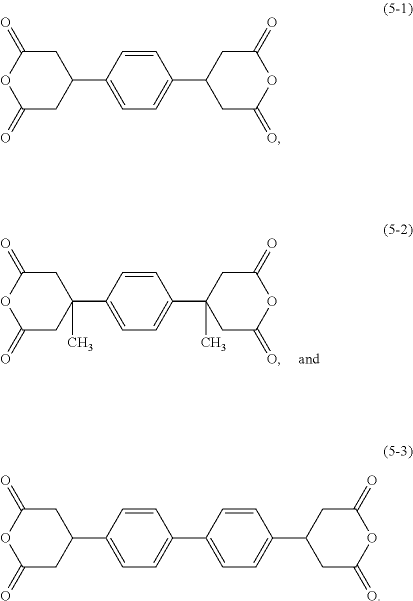 [SMILES: O=C1CC(c2ccc(C3CC(=O)OC(=O)C3)cc2)CC(=O)O1 ; CC1(c2ccc(C3(C)CC(=O)OC(=O)C3)cc2)CC(=O)OC(=O)C1 ; O=C1CC(c2ccc(-c3ccc(C4CC(=O)OC(=O)C4)cc3)cc2)CC(=O)O1]

Preferably, the tetracarboxylic dianhydride compound represented by formula (6) is

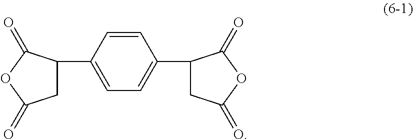 [SMILES: O=C1CC(c2ccc(C3CC(=O)OC3=O)cc2)C(=O)O1]

Preferred examples of the tetracarboxylic dianhydride compound suitable for the present invention include, but are not limited to, 1,2,3,4-cyclobutane tetracarboxylic dianhydride, 1,2,3,4-cyclopentanetetracarboxylic dianhydride, 2,3,5-tricarboxycyclopentylacetic dianhydride, 1,2,4,5-cyclohexanetetracarboxylic dianhydride, 3,4-dicarboxy-1,2,3,4-tetrahydronaphthalene-1-succinic acid dianhydride, pyromellitic dianhydride, 3,3′,4,4′-benzophenonetetracarboxylic dianhydride, 3,3′,4,4′-biphenylsulfonetetracarboxylic dianhydride, and combinations thereof.

The polymer includes at least one compound selected from the group consisting of a polyamic acid compound, a polyimide compound, and a polyimide series block copolymer.

### Polyamic Acid Compound:

A polyamic acid compound is obtained by subjecting the tetracarboxylic dianhydride component and the diamine component to a polycondensation reaction. The polycondensation reaction is conducted in a solvent at a temperature ranging from 0° C. to 100° C. for a period ranging from 1 hour to 24 hours to obtain a reaction solution. The reaction solution is distilled under a reduced pressure in a distiller to obtain the polyamic acid compound. Alternatively, the reaction solution can be treated by pouring it into a large amount of poor solvent to obtain a precipitate, which is then dried under a reduced pressure to obtain the polyamic acid compound.

The tetracarboxylic dianhydride component is used in an amount ranging preferably from 20 moles to 200 moles, and more preferably from 30 moles to 120 moles based on 100 moles of the diamine component.

The solvent for the polycondensation reaction may be the same or different from the solvent used in the liquid crystal alignment agent. Furthermore, there is no particular limitation to the solvent for the polycondensation reaction as long as the solvent is able to dissolve the reactants and the products. Examples of the solvent for the polycondensation reaction include, but are not limited to, (1) aprotic polar solvents, such as 1-methyl-2-pyrrolidone, N,N-dimethylacetamide, N,N-dimethylformamide, dimethylsulfoxide, γ-butyrolactone, tetramethylurea, hexamethylphosphoric acid triamide, or the like; and (2) phenolic solvents, such as m-cresol, xylenol, phenol, halogenated phenols, or the like.

The solvent for the polycondensation reaction is used in an amount ranging preferably from 200 to 2,000 parts by weight, and more preferably from 300 to 1,800 parts by weight based on 100 parts by weight of the mixture of the tetracarboxylic dianhydride component and the diamine component.

Particularly, the aforementioned solvent for the polycondensation reaction can be used in combination with the poor solvent in an appropriate amount that does not cause precipitation of the formed polyamic acid compound. Examples of the poor solvent include, but are not limited to, (1) alcohols, such as methyl alcohol, ethyl alcohol, isopropyl alcohol, cyclohexanol, ethylene glycol, propylene glycol, 1,4-butanediol, triethylene glycol, or the like; (2) ketones, such as acetone, methyl ethyl ketone, methyl isobutyl ketone, cyclohexanone, or the like; (3) esters, such as methyl acetate, ethyl acetate, butyl acetate, diethyl oxalate, diethyl malonate, ethylene glycol ethyl ether acetate, or the like; (4) ethers, such as diethyl ether, ethylene glycol methyl ether, ethylene glycol ethyl ether, ethylene glycol n-propyl ether, ethylene glycol i-propyl ether, ethylene glycol n-butyl ether, ethylene glycol dimethyl ether, diethylene glycol dimethyl ether, or the like; (5) halogenated hydrocarbons, such as dichloromethane, 1,2-dichloroethane, 1,4-dichlorobutane, trichloroethane, chlorobenzene, o-dichlorobenzene, or the like; (6) hydrocarbons, such as tetrahydrofuran, hexane, heptane, octane, benzene, toluene, xylene, or the like; and combinations thereof. The examples of the poor solvent may be used alone or in admixture of two or more.

The poor solvent is used in an amount ranging preferably from 0 to 60 parts by weight, and more preferably from 0 to 50 parts by weight based on 100 parts by weight of the diamine component.

### Polyimide Compound:

The polyimide compound is obtained by subjecting the tetracarboxylic dianhydride component and the diamine component to a polymerization reaction in a solvent to obtain a polyamic acid compound followed by a dehydration/ring-closure reaction, which is conducted by heating in the presence of a dehydrating agent and a catalyst. The amic acid functional group of the polyamic acid compound is converted (i.e., imidized) to the imido functional group via the dehydration/ring-closure reaction so as to obtain the polyimide compound.

The tetracarboxylic dianhydride component and the diamine component for preparation of the polyimide compound are the same as the tetracarboxylic dianhydride component and the diamine component for obtaining the polyamic acid compound.

The solvent for the dehydration/ring-closure reaction may be the same as the solvent used in the liquid crystal alignment agent. The solvent for the dehydration/ring-closure reaction is used in an amount ranging preferably from 200 to 2,000 parts by weight, and more preferably from 300 to 1,800 parts by weight based on 100 parts by weight of the polyamic acid compound.

Heating temperature for the dehydration/ring-closure reaction ranges preferably from 40° C. to 200° C. and more preferably from 40° C. to 150° C. If the heating temperature of the dehydration/ring-closure reaction is lower than 40° C., the dehydration/ring-closure reaction may not be fully implemented and the imidization ratio would be unsatisfactory. If the reaction temperature exceeds 200° C., the weight average molecular weight of the obtained polyimide compound would be reduced.

Examples of the dehydrating agent for the dehydration/ring-closure reaction that is suitable for the present invention include, but are not limited to, acid anhydride compounds, such as acetic anhydride, propionic anhydride, trifluoroacetic anhydride, or the like. The dehydrating agent is used in amount ranging from 0.01 mole to 20 moles per mole of the polyamic compound. Examples of the catalyst for the dehydration/ring-closure reaction that is suitable for the present invention include pyridine compounds, such as pyridine, trimethylpyridine, dimethylpyridine, or the like; and tertiary amines, such as triethylamine, or the like. The catalyst is used in an amount ranging from 0.5 mole to 10 moles per mole of the dehydrating agent.

### Polyimide Series Block Copolymer:

Examples of the polyimide series block copolymer include, but are not limited to, polyamic acid block copolymer, polyimide block copolymer, polyamic acid-polyimide block copolymer, and combinations thereof.

The polyimide series block copolymer is obtained by the polycondensation reaction of a starting material which includes at least one of the aforesaid polyamic acid compounds and/or at least one of the aforesaid polyimide compounds and which can further include a tetracarboxylic dianhydride component and a diamine component in a solvent.

The tetracarboxylic dianhydride component and the diamine component included in the starting material are the same as the tetracarboxylic dianhydride component and the diamine component used for the preparation of the polyamic acid compound, and the solvent used for obtaining the polyimide series block copolymer is the same as the solvent used for the preparation of the liquid crystal alignment agent.

The solvent for the polycondensation reaction is used in an amount ranging preferably from 200 to 2,000 parts by weight, and more preferably from 300 to 1,800 parts by weight based on 100 parts by weight of the starting material.

The operation temperature for the polycondensation reaction ranges preferably from 0° C. to 200° C., and more preferably from 0° C. to 100° C.

Preferably, examples of the starting material used for obtaining the polyimide series block copolymer include, but are not limited to: (1) first and second polyamic acid compounds which are different from each other in terminal groups and structures thereof; (2) first and second polyimide compounds which are different from each other in terminal groups and structures thereof; (3) a polyamic acid compound and a polyimide compound which are different from each other in terminal groups and structures thereof; (4) a polyamic acid compound, a tetracarboxylic dianhydride component, and a diamine component, wherein at least one of the tetracarboxylic dianhydride component and the diamine component is structurally different from the one used for obtaining the polyamic acid compound; (5) a polyimide compound, a tetracarboxylic dianhydride component, and a diamine component, wherein at least one of the tetracarboxylic dianhydride component and the diamine component is structurally different from the one used for obtaining the polyimide compound; (6) a polyamic acid compound, a polyimide compound, a tetracarboxylic dianhydride component, and a diamine component, wherein at least one of the tetracarboxylic dianhydride component and the diamine component is structurally different from the ones used for obtaining the polyamic acid compound and the polyimide compound; (7) first and second polyamic acid compounds, a tetracarboxylic dianhydride component, and a diamine component, wherein the first and second polyamic acid compounds are structurally different from each other; (8) first and second polyimide compounds, a tetracarboxylic dianhydride component, and a diamine component, wherein the first and second polyimide compounds are structurally different from each other; (9) first and second polyamic acid compounds and a diamine component, wherein the first and second polyamic acid compounds have anhydride terminal groups and are structurally different from each other; (10) first and second polyamic acid compounds and a tetracarboxylic dianhydride component, wherein the first and second polyamic acid compounds have amino terminal groups and are structurally different from each other; (11) first and second polyimide compounds and a diamine component, wherein the first and second polyimide compounds have anhydride terminal groups and are structurally different from each other; and (12) first and second polyimide compounds and a tetracarboxylic dianhydride component, wherein the first and second polyimide compounds have amino terminal groups and are structurally different from each other.

Preferably, the polyamic acid compound, the polyimide compound, and the polyimide series block copolymer can be the polymers which are terminal-modified after an adjustment of molecular weight thereof as long as the desirable effects of the present invention are not reduced. The terminal-modified polymers can be used to improve the coating performance of the liquid crystal alignment agent. The process for synthesizing the terminal-modified polymers involves adding a monofunctional compound to the reaction system during the polycondensation reaction for the polyamic acid compound.

Examples of the monofunctional compound include, but are not limited to, (1) monoanhydride compounds, such as maleic anhydride, phthalic anhydride, itaconic anhydride, n-decyl succinic anhydride, n-dodecyl succinic anhydride, n-tetradecyl succinic anhydride, n-hexadecyl succinic anhydride, and the like; (2) monoamine compounds, such as aniline, cyclohexylamine, n-butylamine, n-amylamine, n-hexylamine, n-heptylamine, n-octylamine, n-nonylamine, n-decylamine, n-undecylamine, n-dodecylamine, n-tridecylamine, n-tetradecylamine, n-pentadecylamine, n-hexadecylamine, n-heptadecylamine, n-octadecylamine, n-eicosylamine, and the like; and (3) monoisocyanate compounds, such as phenyl isocyanate, naphthyl isocyanate, and the like.

### Solvent:

There is no particular limitation for the solvent, as long as it is able to dissolve the polymer. Examples of the solvent used in the liquid crystal alignment agent of the present invention include, but are not limited to, N-methyl-2-pyrrolidone, γ-butyrolactone, γ-butyrolactam, 4-hydroxy-4-methyl-2-pentanone, ethylene glycol monomethyl ether, butyl lactate, butyl acetate, methyl methoxypropionate, ethyl ethoxypropionate, ethylene glycol methyl ether, ethylene glycol ethyl ether, ethylene glycol n-propyl ether, ethylene glycol isopropyl ether, ethylene glycol n-butyl ether, ethylene glycol dimethyl ether, ethylene glycol ethyl ether acetate, diglycol dimethyl ether, diglycol diethyl ether, diglycol monomethyl ether, diglycol monoethyl ether, diglycol monomethyl ether acetate, diglycol monoethyl ether acetate, N,N-dimethylformamide, N,N-dimethylethanamide, and the like. The examples of the solvent may be used alone or in admixture of two or more.

In order to provide the liquid crystal alignment agent with superior printability, the solvent used in the liquid crystal alignment agent is in an amount ranging preferably from 1,000 to 2,000 parts by weight, and more preferably from 1,200 to 2,000 parts by weight based on 100 parts by weight of the polymer.

### Additives:

The additives such as epoxy compounds or silane compounds containing functional groups may be added to the liquid crystal alignment agent of the present invention so as to improve the adhesion of the liquid crystal alignment agent to a substrate surface as long as the intended properties of the liquid crystal alignment agent are not impaired. The additives may be used alone or in admixture of two or more.

Examples of the silane compounds containing functional groups include, but are not limited to, 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-trimethoxysilylpropyltriethylenetriamine, 10-trimethoxysilyl-1,4,7-triazadecane, 10-triethoxysilyl-1,4,7-triazadecane, 9-trimethoxysilyl-3,6-diazanonylacetate, 9-triethoxysilyl-3,6-diazanonylacetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, N-bis(oxyethylene)-3-aminopropyltriethoxysilane, and the like.

Examples of the epoxy compounds include, but are not limited to, ethyleneglycoldiglycidyl ether, polyethylene glycoldiglycidyl ether, propyleneglycoldiglycidylether, tripropylene glycol diglycidyl ether, polypropylene glycoldiglycidyl ether, neopentylglycoldiglycidyl ether, 1,6-hexanediol diglycidyl ether, glycerin diglycidyl ether, 2,2-dibromo-neopentyl glycol diglycidyl ether, 1,3,5,6-tetragylcidyl-2,4-hexanediol, N,N,N′,N′-tetragylcidyl-m-xylenediamine, 1,3-bis(N,N-digylcidylaminomethyl)cyclohexane, N,N,N′,N′-tetragylcidyl-4,4′-diaminodiphenylmethane, N,N-gylcidyl-p-glycidoxyaniline, 3-(N-allyl-N-glycidyl)aminopropyltrimethoxysilane, 3-(N,N-diglycidyl)aminopropyltrimethoxysilane, and the like.

There is no particular limitation to the method for manufacturing the liquid crystal alignment agent of the present invention. The general mixing method can be used. For example, the liquid crystal alignment agent of the present invention can be produced by mixing the polyamic acid compound, the polyimide compound, and the optional polyimide series block copolymer to obtain the polymer, which is then added with the solvent and optional additives at a temperature ranging from 0° C. to 200° C., and preferably from 20° C. to 60° C. followed by stirring until the polymer is dissolved in the solvent.

The additive is used in an amount ranging preferably from 0.5 to 50 parts by weight, and more preferably from 1 to 45 parts by weight based on 100 parts by weight of the polymer.

The viscosity of the liquid crystal alignment agent ranges preferably from 12 cps to 35 cps, more preferably from 15 cps to 35 cps, and most preferably from 20 cps to 35 cps at a temperature of 25° C. When the viscosity of the liquid crystal alignment agent is in the range defined above, the liquid crystal alignment agent has superior processing stability, and the liquid crystal display element including the liquid crystal alignment film formed from the liquid crystal alignment agent does not have displaying defects, such as frame defect or linear defect.

### Liquid Crystal Alignment Film:

A liquid crystal alignment film of the present invention is made from the aforesaid liquid crystal alignment agent.

The prepared liquid crystal alignment agent is applied to a substrate by a roller coating method, a spinner coating method, a printing method, an ink-jet method, or the like to form a coating film. The coating film is then treated by a pre-bake treatment, a post-bake treatment and an alignment treatment to obtain a liquid crystal alignment film.

The pre-bake treatment causes the solvent in the coating film to volatilize. The temperature for the pre-bake treatment ranges preferably from 30° C. to 120° C., more preferably from 40° C. to 110° C., and most preferably from 50° C. to 100° C.

The post-bake treatment is carried out to conduct a dehydration/ring-closure (imidization) reaction. The temperature for the post-bake treatment ranges preferably from 150° C. to 300° C., more preferably from 180° C. to 280° C., and most preferably from 200° C. and 250° C.

There is no particular limitation for the alignment treatment. The alignment treatment can be carried out by rubbing the coating film in a certain direction with a roller wound with a cloth which is made from fibers such as nylon, rayon, cotton, or the like.

### Liquid Crystal Display Element:

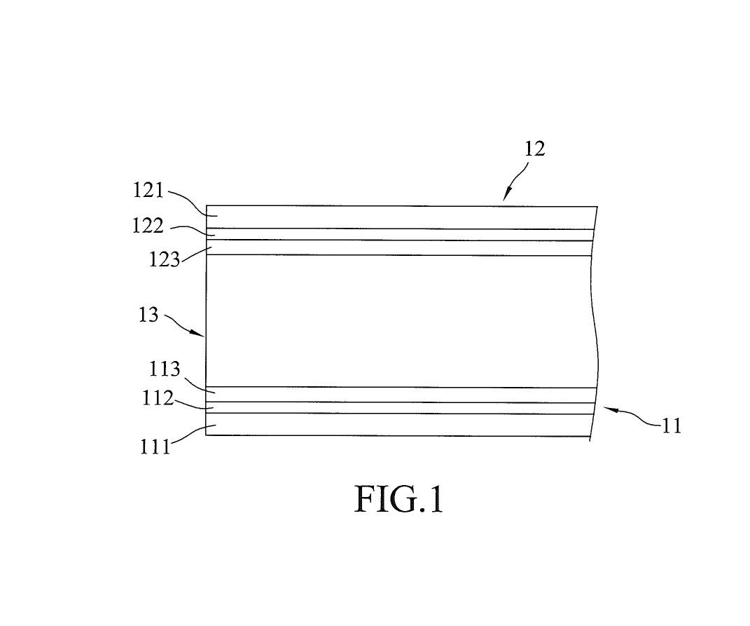

Referring to FIG. 1, a preferred embodiment of a liquid crystal display element according to this invention includes a first unit 11, a second unit 12 spaced apart from the first unit 11, and a liquid crystal unit 13 disposed between the first unit 11 and the second unit 12.

The first unit 11 includes a first substrate 111, a first conductive film 112 formed on the first substrate 111, and a first liquid crystal alignment film 113 formed on the first conductive film 112 and opposite to the first substrate 111.

The second unit 12 includes a second substrate 121, a second conductive film 122 formed on the second substrate 121, and a second liquid crystal alignment film 123 formed on the second conductive film 122 and opposite to the second substrate 121. The first and second liquid crystal alignment films 113, 123 face toward each other.

The first and second substrates 111, 121 suitable for the present invention are made of a transparent material, for example, alkali-free glass, soda-lime glass, hard glass (Pyrex glass), quartz glass, polyethylene terephthalate, polybutylene terephthalate, polyether sulphone, polycarbonate, or the like commonly used in liquid crystal display devices. The first and second conductive films 112, 122 are made of tin oxide (SnO₂), indium oxide-tin oxide (In₂O₃—SnO₂), or the like.

The first and second liquid crystal alignment films 113, 123 are respectively made from the liquid crystal alignment agent of the present invention, and are used for providing the liquid crystal unit 13 with a pretilt angle. The liquid crystal unit 13 can be activated by an electric field cooperatively produced by the first and second conductive films 112, 122.

Examples of the liquid crystals suitable for the liquid crystal unit 13 include, but are not limited to, diaminobenzene liquid crystals, pyridazine liquid crystals, Shiff Base liquid crystals, azoxy liquid crystals, biphenyl liquid crystals, phenylcyclohexane liquid crystals, ester liquid crystals, terphenyl liquid crystals, biphenylcyclohexane liquid crystals, pyrimidine liquid crystals, dioxane liquid crystals, bicyclooctane liquid crystals, and cubane liquid crystals. Furthermore, cholesterol liquid crystals, such as cholesteryl chloride, cholesteryl nonanoate, and cholesteryl carbonate, or chiral agents which are sold under the trade names C-15, CB-15 (manufactured by Merck Company), or the like, or ferroelectric liquid crystals, such as p-(decyloxybenzylidene)-p-amino-(2-methyl-butyl)cinnamate, may be added to the above liquid crystals, as required. The aforesaid examples of the liquid crystals can be used alone or in admixture of two or more.

### EXAMPLES

The following examples are provided to illustrate the preferred embodiments of the invention, and should not be construed as limiting the scope of the invention.

### Preparation of Polyamic Acid Compound

### Synthesis Example 1

A 500 ml four-necked conical flask equipped with a nitrogen inlet, a stirrer, a condenser and a thermometer was purged with nitrogen, and was added with a diamine compound of the aforesaid formula (I-15) (5.91 g, 0.015 mole), p-diaminobenzene (3.24 g, 0.03 mole), benzimidazole-group-containing diamine compound of the aforesaid formula (III-2) (0.31 g, 0.005 mole), and N-methyl-2-pyrrolidone (80 g). Stirring was conducted at room temperature until the aforesaid diamine compounds were dissolved. Pyromellitic dianhydride (10.91 g, 0.05 mole) and N-methyl-2-pyrrolidone (20 g) were then added, and reaction was conducted for 2 hours at room temperature. The reaction solution was then poured into water (1500 ml) to precipitate a polymer. The polymer obtained after filtering was then washed with methanol and filtered three times, and was then dried in a vacuum oven at 60° C. to obtain a polyamic acid compound (A-1-1).

### Synthesis Examples 2 to 5

Polyamic acid compounds (A-1-2) to (A-1-5) were prepared according to the method of Synthesis Example 1, except that the tetracarboxylic dianhydride compounds and the diamine compounds and the amounts thereof shown in Table 1 were used.

### Preparation of Polyimide Compound

### Synthesis Example 6

A 500 ml four-necked conical flask equipped with a nitrogen inlet, a stirrer, a condenser and a thermometer was purged with nitrogen, and was added with a diamine compound of the aforesaid formula (I-15) (5.91 g, 0.015 mole), p-diaminobenzene (3.24 g, 0.03 mole), benzimidazole-group-containing diamine compound of the aforesaid formula (III-2) (0.31 g, 0.005 mole), and N-methyl-2-pyrrolidone (80 g). Stirring was conducted at room temperature until the aforesaid diamine compounds were dissolved. Pyromellitic dianhydride (10.91 g, 0.05 mole) and N-methyl-2-pyrrolidone (20 g) were then added, and reaction was conducted for 6 hours at room temperature. N-methyl-2-pyrrolidone (97 g), acetic anhydride (5.61 g), and pyridine (19.75 g) were then added into the reaction solution. Stirring was continued for 2 hours at 60° C. to conduct imidization reaction. The reaction solution was then poured into water (1500 ml) to precipitate a polymer. The polymer obtained after filtering was then washed with methanol and filtered three times, and was dried in a vacuum oven at 60° C. to obtain a polyimide compound (A-2-1).

### Synthesis Examples 7 to 16

Polyimide compounds (A-2-2) to (A-2-11) were prepared according to the method of Synthesis Example 6, except that the tetracarboxylic dianhydride compounds and the diamine compounds and the amounts thereof shown in Table 1 were used.

### [Preparation of Liquid Crystal Alignment Agent, Liquid Crystal Alignment Film, and Liquid Crystal Display Element]

### Example 1

100 parts by weight of the polyamic acid compound of Synthesis Example 1, 725 parts by weight of N-methyl-2-pyrrolidone, and 725 parts by weight of ethylene glycol n-butyl ether were stirred at room temperature to form a liquid crystal alignment agent.

The liquid crystal alignment agent was coated onto two glass substrates each having an ITO (indium-tin-oxide) conductive film using a printing machine (manufactured by Japan Nissha Printing Co., Ltd., Model S15-036), after which the glass substrates coated with the alignment agent were pre-baked on a heating plate at a temperature of 100° C. for 5 minutes, and were then post-baked in a hot air circulation baking oven at a temperature of 220° C. for 30 minutes. An alignment process was then carried out on the surface of the film. Two glass substrates each coated with the liquid crystal alignment film were thus manufactured by the aforementioned steps.

Thermo-compression adhesive agent was applied to one glass substrate, and spacers of 4 μm were sprayed on the other glass substrate. The two glass substrates were aligned and bonded together in a vertical direction, and then 10 kg of pressure was applied using a thermocompressor to carry out thermocompression at 150° C. Liquid crystal was poured using a liquid crystal pouring machine (manufactured by Shimadzu Corporation, Model ALIS-100X-CH), and ultraviolet light was used to harden a sealant to seal the liquid crystal injection hole, and then an annealing treatment was conducted in an oven at 60° C. for 30 minutes, by means of which a liquid crystal display element was manufactured.

The liquid crystal alignment agent and the liquid crystal display element obtained thereby were evaluated according to the following evaluation methods. The evaluation results are shown in Table 2.

### Examples 2 to 11 and Comparative Examples 1 to 5

Examples 2 to 11 and Comparative Examples 1 to 5 were conducted in a manner identical to Example 1 using the polymers, the solvents, and the additives and the amounts thereof shown in Table 2 to prepare the liquid crystal alignment agents, the liquid crystal alignment films, and the liquid crystal display elements. The obtained liquid crystal alignment agents, the liquid crystal alignment films, and the liquid crystal display elements were evaluated according to the following evaluation methods. The results are shown in Table 2.

### [Evaluation Items]

### 1. Imidization Ratio:

Imidization ratio refers to a ratio of the number of the imide ring to a total of the number of the amic acid functional group and the number of the imide ring in the polyimide polymer, and is represented in percentage.

Each of the polymers obtained from Synthesis Examples 1 to 16 was dried under a reduced pressure, and was then dissolved in a proper deuteration solvent, for example, deuterated dimethylsulfoxide. ¹H-NMR determination was conducted at room temperature (for example, 25° C.) using tetramethylsilane as a standard. The imidization ratio (in %) was calculated using the following formula:

Imidization ratio(%)=[1−Δ1/(Δ2×α)]×100

wherein

Δ1 is a peak area produced by a chemical shift around 10 ppm of the proton of NH group;

Δ2 is a peak area of the proton other than that of the NH group; and

α is a ratio of the number of the proton of the NH group to the number of the proton other than that of the NH group in a precursor of polyamic acid polymer.

### 2. Viscosity:

Viscosity of each of the liquid crystal alignment agents prepared from Examples 1 to 11 and Comparative Examples 1 to 5 was determined using an ELD-type viscometer (manufactured by Toki Sangyo Co., Ltd., RE-80L) at a rotational speed of 20 rpm and at a temperature of 25° C. The results are recorded in a unit of cps.

### 3. Processing Stability:

Each of the liquid crystal alignment agents prepared from Examples 1 to 11 and Comparative Examples 1 to 5 was used to produce a liquid crystal display element. In the manufacturing process of the liquid crystal display element, the pre-baking treatment was conducted at 80° C., 90° C., 100° C., 110° C., and 120° C. so as to produce five liquid crystal display elements. An area (3×3 cm²) of a display face of the liquid crystal display element was randomly taken to serve as a testing area and the testing area was then evenly divided into 9 region parts. The pretilt angle uniformity (P) of the testing areas of the liquid crystal display elements was measured. The uniformity of the pretilt angle subsequently was calculated as follows:

P=(Pretilt Angleₘₐₓ−Pretilt Angleₘᵢₙ)/(2×Pretilt Angle_{average})×100%

The variation of the pretilt angle uniformity (P) was calculated as follows:

Variation of P=(Pₘₐₓ−Pₘᵢₙ)×100%

The results were evaluated according to the following standards:

### ⊚): Variation of P≦2%

### ◯: 2%<Variation of P≦5%

### Δ: 5%<Variation of P≦10

### X: Variation of P>10%

### 4. Reliability:

The test for reliability of each of the liquid crystal display elements prepared from Examples 1 to 11 and Comparative Examples 1 to 5 was carried out at a temperature of 65° C. and relative humidity of 85% for 120 hours. The voltage holding ratio of each of the liquid crystal display elements was measured using an electrical measuring machine (manufactured by TOYO Corporation, Model 6254). A voltage of 4 volts was applied for 2 milliseconds. The applied voltage was held for 1667 milliseconds. After the applied voltage was cut off for 1667 milliseconds, the voltage holding ratio was measured and the reliability of each of the liquid crystal display elements was evaluated according to the following standards:

⊚: Voltage holding ratio≧94%
◯: 94%>Voltage holding ratio≧92%
Δ: 92%>Voltage holding ratio≧90%
X: Voltage holding ratio<90%

TABLE 1

| | | Synthesis Examples | | | | | | | | | | | | | | | |
|---|---|---|---|---|---|---|---|---|---|---|---|---|---|---|---|---|---|
| | | 1 | 2 | 3 | 4 | 5 | 6 | 7 | 8 | 9 | 10 | 11 | 12 | 13 | 14 | 15 | 16 |
| Components | | A- | A- | A- | A- | A- | A- | A- | A- | A- | A- | A- | A- | A- | A- | A-2- | A-2- |
| Unit: mole (%) | | 1-1 | 1-2 | 1-3 | 1-4 | 1-5 | 2-1 | 2-2 | 2-3 | 2-4 | 2-5 | 2-6 | 2-7 | 2-8 | 2-9 | 10 | 11 |
| Tetracarboxylic | a-1 | 100 | — | — | 100 | — | 100 | — | — | — | 100 | — | — | 50 | 100 | — | 50 |
| Dianhydride | a-2 | — | 100 | 50 | — | 100 | — | 100 | 50 | 102 | — | 100 | — | 50 | — | 100 | — |
| | a-3 | — | — | 50 | — | — | — | — | 50 | — | — | — | 100 | — | — | — | 50 |
| Diamine | b-1-1 | 30 | — | — | — | — | 30 | — | — | 40 | — | — | — | 50 | 30 | — | — |
| Compound of | b-1-2 | — | 20 | — | — | 20 | — | 20 | — | — | 50 | — | — | 5 | — | — | — |
| Formula (I) | b-1-3 | — | — | 25 | — | — | — | — | 25 | — | — | 10 | 12 | — | — | — | — |
| Benzimidazole-group- | b-2-1 | 10 | — | — | 10 | — | 10 | — | — | 20 | — | — | 40 | — | — | — | — |
| containing Diamine | b-2-2 | — | 20 | — | — | — | — | 20 | — | — | 5 | 10 | — | 5 | — | 20 | — |
| Compound | b-2-3 | — | — | 30 | — | — | — | — | 30 | — | — | 10 | — | — | — | — | — |
| Another Diamine | b-3-1 | 60 | — | — | 90 | — | 60 | — | — | 40 | — | 70 | — | — | 70 | — | — |
| Compound | b-3-2 | — | 60 | — | — | 80 | — | 60 | 20 | — | — | — | 50 | — | — | 80 | — |
| | b-3-3 | — | — | 45 | — | — | — | — | 25 | — | 45 | — | — | 40 | — | — | 100 |

| | | | | | | | | | | | | | | | | |
|---|---|---|---|---|---|---|---|---|---|---|---|---|---|---|---|---|
| (b-1)/(b-2) | 3 | 1 | 0.8 | 0 | — | 3 | 1 | 0.8 | 2 | 10 | 0.5 | 0.3 | 11 | — | 0 | — |
| Imidization Ratio(%) | 0 | 0 | 0 | 0 | 0 | 15 | 20 | 33 | 39 | 46 | 82 | 65 | 90 | 70 | 63 | 30 |

Notes:
┌—┘: not added
a-1: pyromellitic dianhydride
a-2: 3,4-dicarboxy-1,2,3,4-tetrahydronaphthalene-1-succinic acid dianhydride
a-3: 1,2,4,5-cyclohexane tetracarboxylic dianhydride
b-1-1: a compound represented by formula (I-15)
b-1-2: a compound represented by formula (I-9)
b-1-3: a compound represented by formula (I-2)
b-2-1: a compound represented by formula (III-2)
b-2-2: a compound represented by formula (III-3)
b-2-3: a compound represented by formula (IV-3)
b-3-1: p-diaminobenzene
b-3-2: 4,4′-diaminodiphenyl methane
b-3-3: 4,4′-diaminodiphenyl ether

TABLE 2

| Components | | | | | | | | | | | | | | | | | |
|---|---|---|---|---|---|---|---|---|---|---|---|---|---|---|---|---|---|
| Unit: parts by | | Examples | | | | | | | | | | | Comparative Examples | | | | |
| weight | | 1 | 2 | 3 | 4 | 5 | 6 | 7 | 8 | 9 | 10 | 11 | 1 | 2 | 3 | 4 | 5 |
| Polymers | A-1-1 | 100 | — | — | — | — | — | — | — | — | — | — | — | — | — | — | — |
| | A-1-2 | — | 100 | — | — | — | — | — | — | — | — | — | — | — | — | — | — |
| | A-1-3 | — | — | 100 | — | — | — | — | — | — | — | — | — | — | — | — | — |
| | A-1-4 | — | — | — | — | — | — | — | — | — | — | — | 100 | — | — | — | — |
| | A-1-5 | — | — | — | — | — | — | — | — | — | — | — | — | 100 | — | — | — |
| | A-2-1 | — | — | — | 100 | — | — | — | — | — | — | — | — | — | — | — | — |
| | A-2-2 | — | — | — | — | 100 | — | — | — | — | — | — | — | — | — | — | — |
| | A-2-3 | — | — | — | — | — | 100 | — | — | — | — | — | — | — | — | — | — |
| | A-2-4 | — | — | — | — | — | — | 100 | — | — | — | — | — | — | — | — | — |
| | A-2-5 | — | — | — | — | — | — | — | 100 | — | — | — | — | — | — | — | — |
| | A-2-6 | — | — | — | — | — | — | — | — | 100 | — | — | — | — | — | — | — |
| | A-2-7 | — | — | — | — | — | — | — | — | — | 100 | — | — | — | — | — | — |
| | A-2-8 | — | — | — | — | — | — | — | — | — | — | 100 | — | — | — | — | — |
| | A-2-9 | — | — | — | — | — | — | — | — | — | — | — | — | — | 100 | — | — |
| | A-2-10 | — | — | — | — | — | — | — | — | — | — | — | — | — | — | 100 | — |
| | A-2-11 | — | — | — | — | — | — | — | — | — | — | — | — | — | — | — | 100 |
| Solvents | B-1 | 725 | — | — | 1000 | 1300 | 1500 | 725 | — | 1500 | 800 | — | 725 | — | — | 1300 | — |
| | B-2 | 725 | 1500 | — | 500 | — | — | 725 | 1200 | — | — | 2000 | 725 | 1500 | — | — | 1200 |
| | B-3 | — | — | 1800 | — | 50 | — | — | — | 200 | 800 | — | — | — | 1800 | 50 | — |
| Additives | C-1 | — | 10 | — | — | — | 8 | — | — | 5 | — | — | — | 10 | — | — | — |
| | C-2 | — | — | — | 5 | — | 2 | — | — | — | 3 | — | — | — | — | — | — |

| Viscosity (cps) | | 22 | 26 | 29 | 26 | 20 | 30 | 31 | 20 | 31 | 24 | 16 | 23 | 8 | 7 | 25 | 9 |
|---|---|---|---|---|---|---|---|---|---|---|---|---|---|---|---|---|---|
| Results | Processing | ⊚ | ⊚ | ⊚ | ⊚ | ⊚ | ⊚ | ⊚ | ⊚ | ⊚ | ◯ | ◯ | X | X | X | X | X |
| | Stability | | | | | | | | | | | | | | | | |
| | Reliability | ◯ | ◯ | ◯ | ◯ | ◯ | ⊚ | ⊚ | ⊚ | ⊚ | ⊚ | ⊚ | X | X | X | X | X |

Note:
B-1: N-methyl-2-pyrrolidone
B-2: ethylene glycol n-butyl ether
B-3: N,N-dimethylacetamide
C-1: N,N,N′,N′-tetraglycidyl-4,4′-diaminodiphenylmethane
C-2: N,N-glycidyl-p-glycidoxyaniline

As shown in Table 2, in Examples 1 to 11, a combination of the diamine compound represented by formula (I) and the benzimidazole-group-containing diamine compound is used for obtaining the polymer, the liquid crystal alignment agents thus produced have superior processing stability, and the liquid crystal display elements made therefrom have superior reliability.

However, in Comparative Examples 1 and 4, the diamine compound represented by formula (I) was not used for obtaining the polymer, the liquid crystal alignment agents thus produced have inferior processing stability, and the liquid crystal display elements made therefrom have inferior reliability.

In Comparative Examples 2 and 3, the benzimidazole-group-containing diamine compound was not used for obtaining the polymer, the liquid crystal alignment agents thus produced have inferior processing stability, and the liquid crystal display elements made therefrom have inferior reliability.

In Comparative Example 5, neither the diamine compound represented by formula (I) nor the benzimidazole-group-containing diamine compound was used for obtaining the polymer, and the liquid crystal alignment agents thus produced have inferior processing stability, and the liquid crystal display elements made therefrom have inferior reliability.

Furthermore, in Examples 1 to 9, a combination of the diamine compound represented by formula (I) and the benzimidazole-group-containing diamine compound in a molar ratio of the diamine compound represented by formula (I) to the benzimidazole-group-containing diamine compound ranging from 0.5 to 10 was used for obtaining the polymer, and the liquid crystal alignment agents thus produced have more superior processing stability.

In Examples 6 to 11, a combination of the diamine compound represented by formula (I) and the benzimidazole-group-containing diamine compound was used for obtaining the polymer in which the imidization ratio ranges from 30% to 90%, and the liquid crystal display elements thus made have more superior reliability.

In view of the aforesaid, in the present invention, a liquid crystal alignment agent having superior processing stability can be produced from a polymer obtained using a combination of the diamine compound represented by formula (I) and the benzimidazole-group-containing diamine compound. Furthermore, a liquid crystal display element made from the liquid crystal alignment agent has superior reliability.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A liquid crystal alignment agent, comprising:
a polymer obtained by subjecting a mixture including a tetracarboxylic dianhydride component and a diamine component to a reaction; and
a solvent,
wherein
said diamine component includes a diamine compound of formula (I), a benzimidazole-group-containing diamine compound, and a diamine compound other than said diamine compound of formula (I) and said benzimidazole-group-containing diamine compound, 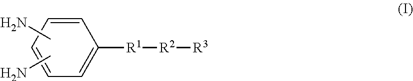
where
R¹ represents a C₁-C₁₂ alkylene group or a C₁-C₁₂ haloalkylene group,
R² represents 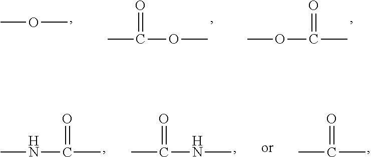
and
R³ represents a cholesteryl group, an organic group of formula (II), or a group of —R³¹—R³²—R³³,
where
R³¹ represents a C₁-C₁₀ alkylene group,
R³² represents 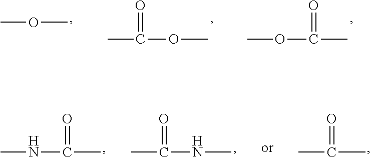
and
R³³ represents a cholesteryl group or an organic group of formula (II), 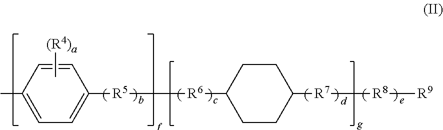
where
each R⁴ independently represents hydrogen, fluorine, or methyl,
each of R⁵, R⁶, and R⁷ independently represents a single bond, 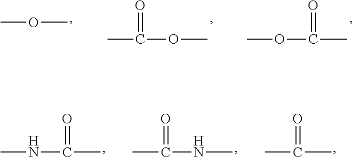
or a C₁-C₃ alkylene,
each R⁸ independently represents 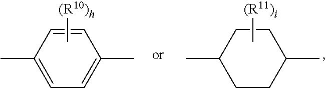
where
each of R¹⁰ and R¹¹ independently represents hydrogen, fluorine, or methyl,
each R⁹ independently represents hydrogen, fluorine, a C₁-C₁₂ alkyl group, a C₁-C₁₂ fluoroalkyl group, a C₁-C₁₂ alkoxyl group, —OCH₂F'′—OCHF₂, or —OCF₃,
a represents 1 or 2,
b, c, and d independently represent an integer ranging from 0 to 4,
f, and g independently represent an integer ranging from 0 to 3 with the proviso that e, f, and g are not 0 at the same time, and
h and i independently represent 1 or 2.

2. The liquid crystal alignment agent as claimed in claim 1, wherein said benzimidazole-group-containing diamine compound is selected from the group consisting of diamine compounds of formulas (III)-(VII): 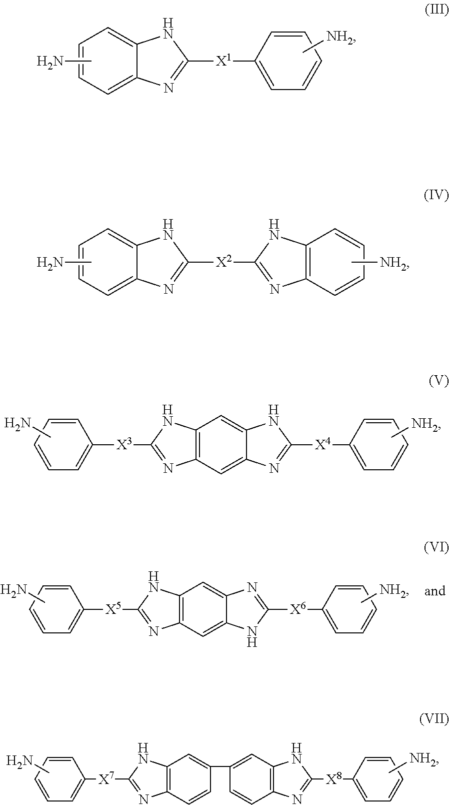
where
X¹, X³, X⁴, X⁵, X⁶, X⁷, and X⁸ independently represent a single bond or a C₁-C₈ alkyl group, and
X² represents a C₁-C₈ alkyl group or phenyl.

3. The liquid crystal alignment agent as claimed in claim 1, wherein said diamine compound of formula (I) is in an amount ranging from 10 moles to 55 moles and said benzimidazole-group-containing diamine compound is in an amount ranging from 5 moles to 40 moles based on 100 moles of said diamine component.

4. The liquid crystal alignment agent as claimed in claim 1, wherein a molar ratio of said diamine compound of formula (I) to said benzimidazole-group-containing diamine compound ranges from 0.5 to 10.

5. The liquid crystal alignment agent as claimed in claim 4, wherein said molar ratio of said diamine compound of formula (I) to said benzimidazole-group-containing diamine compound ranges from 0.7 to 7.

6. The liquid crystal alignment agent as claimed in claim 5, wherein said molar ratio of said diamine compound of formula (I) to said benzimidazole-group-containing diamine compound ranges from 1 to 5.

7. The liquid crystal alignment agent as claimed in claim 1, wherein said polymer has an imidization ratio ranging from 30% to 90%.

8. The liquid crystal alignment agent as claimed in claim 1, having a viscosity at 25° C. ranging from 12 cps to 35 cps.

9. A liquid crystal alignment film formed from the liquid crystal alignment agent as claimed in claim 1.

10. A liquid crystal display element, comprising the liquid crystal alignment film as claimed in claim 9.
